(19) United States
(12) Patent Application Publication
(10) Pub. No.: US 2016/0157182 A1
(43) Pub. Date: Jun. 2, 2016

(54) BASE STATION, COMMUNICATION SYSTEM, AND COMMUNICATION CONTROL METHOD

(71) Applicant: FUJITSU LIMITED, Kawasaki-shi (JP)

(72) Inventors: Yasunari IZAWA, Sagamihara (JP); Ryota SHINOJIMA, Kawasaki (JP); Takeshi KUNUGI, Yokohama (JP)

(21) Appl. No.: 14/949,618

(22) Filed: Nov. 23, 2015

(30) Foreign Application Priority Data
Nov. 28, 2014 (JP) 2014-242254
Sep. 16, 2015 (JP) 2015-183018

(51) Int. Cl. H04W 52/04; H04W 72/04

(52) U.S. Cl. CPC H04W 52/04; H04W 72/0473; H04W 72/042; H04W 88/08

(57) ABSTRACT

A base station having an upper limit of total downlink transmission power includes a monitoring unit that monitors the total downlink transmission power, and a control unit that, when the total downlink transmission power is equal to or higher than a threshold, changes a transmission destination of data addressed to a first user terminal from the first user terminal to a second user terminal, the second user terminal being capable of direct communication with the first user terminal without requiring the base station between the second user terminal and the first user terminal, the second user terminal having, as downlink transmission power from the base station, second downlink transmission power lower than first downlink transmission power to the first user terminal.

### CROSS-REFERENCE TO RELATED APPLICATIONS

This application is based upon and claims the benefit of priority of the prior Japanese Patent Application No. 2014-242254, filed on Nov. 28, 2014, and the prior Japanese Patent Application No. 2015-183018, filed on Sep. 16, 2015, the entire contents of which are incorporated herein by reference.

### FIELD

The embodiments discussed herein are related to a base station, a communication system, and a communication control method.

### BACKGROUND

Studies have been being conducted in these years on next-generation wireless communication technologies in wireless communication systems such as a cellular system as one of portable telephone systems in order to achieve, for example, even higher speeds and greater capacities of wireless communication. A communication standard called “Long Term Evolution (LTE)”, for example, is formulated in the 3rd Generation Partnership Project (3GPP) as one of standards bodies. Following the formulation of the LTE, the 3GPP uses the LTE wireless communication technology as a basis for examining a communication standard called “LTE-Advanced (LTE-A)” in order to further enhance performance.

A technique that enables direct communication between user terminals, known as “device-to-device (D2D) communication”, is now available. The D2D communication represents one of the communication technologies that are likely to be introduced to the LTE-A in the future and that are currently being technologically studied at the 3GPP. Whereas in the known cellular communication, nearby user terminals invariably perform communication via a base station, the D2D communication allows the nearby user terminals to perform direct communication without requiring the base station therebetween. Enabling the D2D communication allows the user terminals to communicate with each other even, for example, in the event of a natural disaster in which the base station may stop functioning properly and disable communication.

A study is also being underway about the introduction of a user terminal that is capable of both the cellular communication and the D2D communication. In the following, a user terminal capable of both the cellular communication and the D2D communication may be referred to as a “D2D terminal” and a user terminal capable of only the cellular communication may be referred to as a “cellular terminal”.

Examples of related-art are described in Japanese Laid-open Patent Publication No. 2012-249317, in Japanese Laid-open Patent Publication No. 2008-289045, in Japanese Laid-open Patent Publication No. 2006-013811, in Japanese Laid-open Patent Publication No. 2007-251712, in Japanese Laid-open Patent Publication No. HEI07-059144, in Japanese Laid-open Patent Publication No. 2005-341300, in 3GPP TS 36.300 (12.1.0), and in 3GPP TR 36.843.

A base station communicates simultaneously with a plurality of user terminals located within a cell formed by the base station (host base station).

In general, the base station transmits data to a user terminal located near an end of a cell (a cell end) with downlink transmission power higher than that for a user terminal located near the center of the cell in order to maintain desirable communication quality. Furthermore, for a user terminal located, for example, in a place behind a building or an underground site where radio waves are hard to reach, the base station transmits data with the downlink transmission power higher than that for a user terminal located at a site where the radio waves are easy to reach in order to maintain desirable communication quality.

Meanwhile, there is an upper limit to a total amount of the downlink transmission power to be used simultaneously for a plurality of user terminals by a single base station (may be referred to in the following as “total downlink transmission power”).

Thus, an increase in the number of user terminals to which data is transmitted with large downlink transmission power from the base station, for example, user terminals located near the cell end or sites where the radio waves are hard to reach, results in a decreased number of user terminals that can communicate with a single base station simultaneously, specifically, a decreased number of user terminals that can be simultaneously accommodated within a single cell. Specifically, an increase in the number of user terminals to which data is transmitted with large downlink transmission power from the base station reduces transmission capacity (specifically, system capacity) of a wireless communication system.

### SUMMARY

According to an aspect of an embodiment, a base station having an upper limit of total downlink transmission power includes a monitoring unit that monitors the total downlink transmission power, and a control unit that, when the total downlink transmission power is equal to or higher than a threshold, changes a transmission destination of data addressed to a first user terminal from the first user terminal to a second user terminal, the second user terminal being capable of direct communication with the first user terminal without requiring the base station between the second user terminal and the first user terminal, the second user terminal having, as downlink transmission power from the base station, second downlink transmission power lower than first downlink transmission power to the first user terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a communication system according to a first embodiment;

FIG. 2 is a diagram illustrating the communication system according to the first embodiment;

FIG. 3 is a diagram illustrating the communication system according to the first embodiment;

FIG. 4 is a functional block diagram illustrating a base station according to the first embodiment;

FIG. 5 is a functional block diagram illustrating a user terminal according to the first embodiment;

FIG. 6 is a flowchart for illustrating processing performed at the base station according to the first embodiment;

FIG. 7 is a diagram illustrating a processing sequence performed by the communication system according to the first embodiment;

FIG. 8 is a diagram illustrating a processing sequence performed by the communication system according to the first embodiment;

FIG. 9 is a flowchart for illustrating a relayed terminal selection process according to the first embodiment;

FIG. 10 is a flowchart for illustrating a relay terminal selection process according to the first embodiment;

FIG. 11 is a table for illustrating a specific example of the selection process according to the first embodiment;

FIG. 12 is a table for illustrating a specific example of the selection process according to the first embodiment;

FIG. 13 is a table for illustrating a specific example of the selection process according to the first embodiment;

FIG. 14 is a table for illustrating a specific example of the selection process according to the first embodiment;

FIG. 15 is a diagram illustrating a communication system according to a second embodiment;

FIG. 16 is a flowchart for illustrating processing performed at the base station according to the second embodiment;

FIG. 17 is a flowchart for illustrating processing performed at the base station according to the second embodiment;

FIG. 18 is a flowchart for illustrating an additional relayed terminal selection process according to the second embodiment;

FIG. 19 is a table for illustrating a specific example of the selection process according to the second embodiment;

FIG. 20 is a table for illustrating a specific example of the selection process according to the second embodiment;

FIG. 21 is a diagram illustrating a communication system according to a third embodiment;

FIG. 22 is a diagram illustrating the communication system according to the third embodiment;

FIG. 23 is a diagram illustrating a processing sequence performed by the communication system according to the third embodiment;

FIG. 24 is a table for illustrating a specific example of the selection process according to the third embodiment;

FIG. 25 is a table for illustrating a specific example of the selection process according to the third embodiment;

FIG. 26 is a diagram illustrating a processing sequence performed by a communication system according to a fourth embodiment;

FIG. 27 is a diagram illustrating a communication system according to a fifth embodiment;

FIG. 28 is a diagram illustrating the communication system according to the fifth embodiment;

FIG. 29 is a diagram illustrating a processing sequence performed by the communication system according to the fifth embodiment;

FIG. 30 is a table for illustrating a specific example of a selection process according to the fifth embodiment;

FIG. 31 is a diagram illustrating a processing sequence performed by a communication system according to a sixth embodiment;

FIG. 32 is a diagram illustrating a hardware configuration of the base station; and

FIG. 33 is a diagram illustrating a hardware configuration of the user terminal.

### DESCRIPTION OF EMBODIMENTS

Preferred embodiments of the present invention will be explained with reference to accompanying drawings. It is to be understood that these embodiments are not restrictive of the disclosed base station, communication system, and communication control method, as claimed. Corresponding elements having identical functions and corresponding steps performing identical operations in all embodiments to be described hereunder are denoted by the same reference numerals and duplicate descriptions thereof will be omitted.

### [a] First Embodiment

### Configuration of Communication System

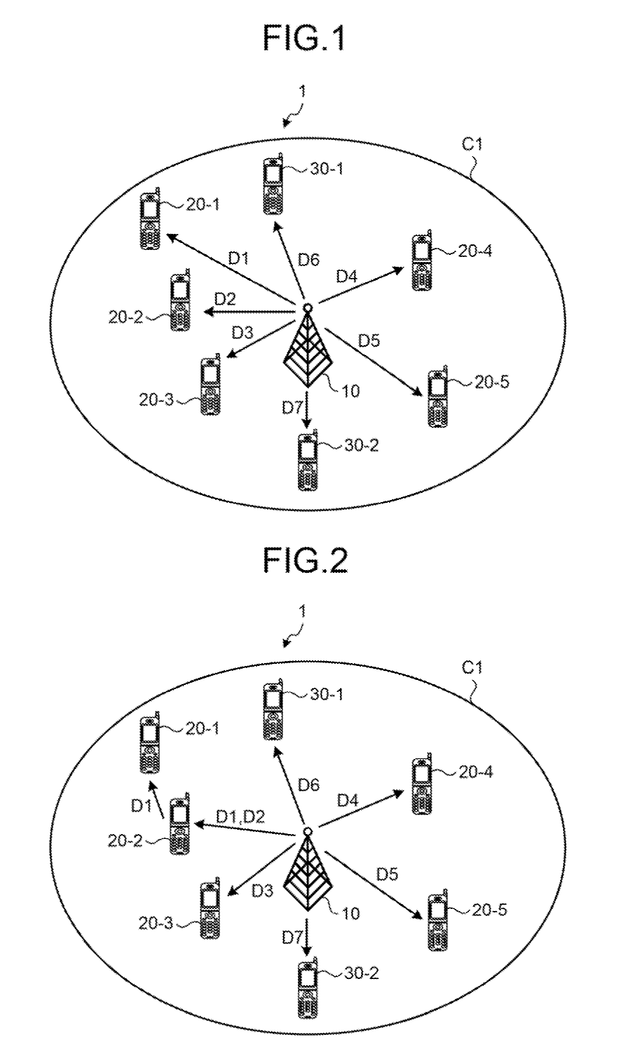

FIG. 1 is a diagram illustrating a communication system according to a first embodiment. In FIG. 1, this communication system 1 includes a base station 10, user terminals 20-1 to 20-5, and user terminals 30-1 and 30-2. The user terminals 20-1 to 20-5 are each a D2D terminal and the user terminals 30-1 and 30-2 are each a cellular terminal. The base station 10 forms a cell C1 in which the user terminals 20-1 to 20-5 and the user terminals 30-1 and 30-2 are located. Thus, in FIG. 1, the base station 10 directly transmits data D1 to D7 to the user terminals 20-1 to 20-5 and the user terminals 30-1 and 30-2, respectively, through cellular communication.

In the following, the user terminals 20-1 to 20-5, when one is not to be distinguished from another, may be referred to generically as a “user terminal 20” and the user terminals 30-1 and 30-2, when one is not to be distinguished from the other, may be referred to generically as a “user terminal 30”. Furthermore, the user terminals 20-1 to 20-5 and the user terminals 30-1 and 30-2, when one is not to be distinguished from another, may be referred to simply as a “user terminal”.

The total downlink transmission power from the base station 10 has an upper limit. Thus, the base station 10 constantly monitors the total downlink transmission power from the base station 10 in the state illustrated in FIG. 1 to determine whether the total downlink transmission power is equal to or higher than a threshold TH1. The threshold TH1 is a value lower than an upper limit of the total downlink transmission power and is set to, for example, “the upper limit of the total downlink transmission power×0.8”. When the total downlink transmission power of the base station 10 is lower than the threshold TH1, the communication system 1 maintains the state illustrated in FIG. 1.

When the total downlink transmission power of the base station 10 is equal to or higher than the threshold TH1, the communication system 1 shifts from the state illustrated in FIG. 1 to the state illustrated in FIG. 2, for example. FIG. 2 is a diagram illustrating the communication system according to the first embodiment. Specifically, in FIG. 2, a transmission destination of the data D1 addressed to the user terminal 20-1 is changed from the user terminal 20-1 to the user terminal 20-2 and the data D1 addressed to the user terminal 20-1 is transmitted to the user terminal 20-1 through the user terminal 20-2. The user terminal 20-2, because being located close to the user terminal 20-1, is capable of D2D communication with the user terminal 20-1. In addition, the downlink transmission power from the base station 10 to the user terminal 20-2 is lower than the downlink transmission power from the base station 10 to the user terminal 20-1. Thus, the shift of the communication system 1 from the state illustrated in FIG. 1 to the state illustrated in FIG. 2 eliminates the need for transmission from the base station 10 to the user terminal 20-1, so that the total downlink transmission power from the base station 10 is reduced by the amount of the downlink transmission power to the user terminal 20-1.

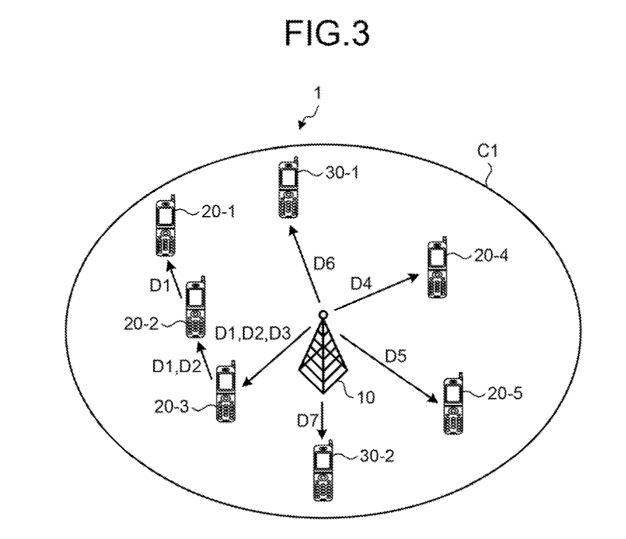

When the total downlink transmission power of the base station 10 is equal to or higher than the threshold TH1 even after the transmission destination of the data D1 addressed to the user terminal 20-1 has been changed from the user terminal 20-1 to the user terminal 20-2, the communication system 1 shifts from the state illustrated in FIG. 2 to the state illustrated in FIG. 3, for example. FIG. 3 is an example diagram illustrating the communication system according to the first embodiment. Specifically, in FIG. 3, the transmission destination of the data D2 addressed to the user terminal 20-2 is changed from the user terminal 20-2 to the user terminal 20-3 and the data D2 addressed to the user terminal 20-2 is transmitted to the user terminal 20-2 through the user terminal 20-3. The user terminal 20-3, because being located close to the user terminal 20-2, is capable of D2D communication with the user terminal 20-2. In addition, the downlink transmission power from the base station 10 to the user terminal 20-3 is lower than the downlink transmission power from the base station 10 to the user terminal 20-2. Thus, the shift of the communication system 1 from the state illustrated in FIG. 2 to the state illustrated in FIG. 3 further eliminates the need for transmission from the base station 10 to the user terminal 20-2, so that the total downlink transmission power from the base station 10 is reduced further by the amount of the downlink transmission power to the user terminal 20-2. The shift of the communication system 1 from the state illustrated in FIG. 2 to the state illustrated in FIG. 3 results in the communication system 1 maintaining the state illustrated in FIG. 3 as long as the total downlink transmission power of the base station 10 that has fallen below the threshold TH1 remains lower than the threshold TH1.

Configuration of Base Station

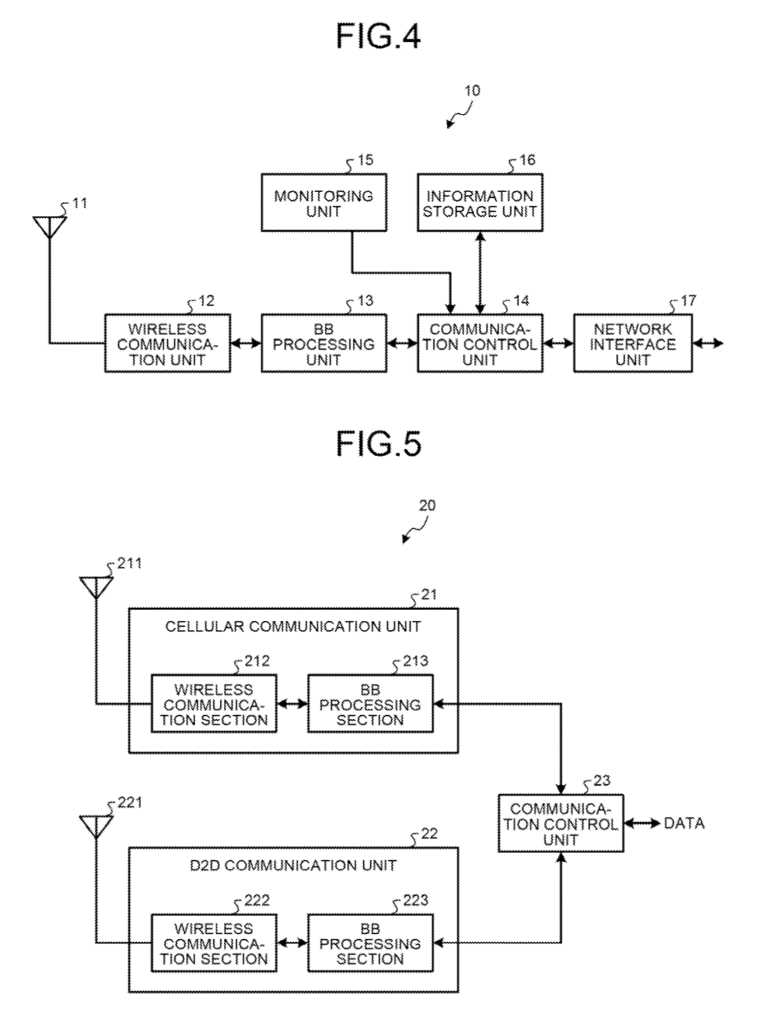

FIG. 4 is a functional block diagram illustrating the base station according to the first embodiment. In FIG. 4, the base station 10 includes an antenna 11, a wireless communication unit 12, a base band (BB) processing unit 13, a communication control unit 14, a monitoring unit 15, an information storage unit 16, and a network interface unit 17.

The network interface unit 17 is connected to a core network (not illustrated) and another base station. The network interface unit 17 transmits data and a control message input from the communication control unit 14 to the core network or another base station. The network interface unit 17 also outputs data and a control message received from the core network or another base station to the communication control unit 14.

The communication control unit 14 creates various types of control messages and outputs the various types of control messages to the BB processing unit 13 or the network interface unit 17. At this time, the communication control unit 14 creates the control messages on the basis of various types of information stored in the information storage unit 16 and a result of monitoring by the monitoring unit 15. The communication control unit 14 also outputs data and a control message input from the BB processing unit 13 to the network interface unit 17 and outputs data and a control message input from the network interface unit 17 to the BB processing unit 13.

The BB processing unit 13 subjects a control message and data input from the communication control unit 14 to BB processing such as encoding and modulation, thereby generating a base band transmission signal. The BB processing unit 13 then outputs the generated transmission signal to the wireless communication unit 12. The BB processing unit 13 also subjects a base band reception signal input from the wireless communication unit 12 to BB processing such as demodulation and decoding, thereby acquiring a control message and data. The BB processing unit 13 then outputs the control message and data to the communication control unit 14.

The wireless communication unit 12 subjects the base band transmission signal input from the BB processing unit 13 to digital-to-analog conversion, up-conversion, and other types of processing and transmits the up-converted transmission signal to a user terminal via the antenna 11. The transmission signal may be multiplexed with data addressed to a plurality of user terminals. In the state illustrated in FIG. 2, for example, the transmission signal addressed to the user terminal 20-1 is multiplexed with the data D1 addressed to the user terminal 20-1 and the data D2 addressed to the user terminal 20-2. Alternatively, in the state illustrated in FIG. 3, for example, the transmission signal addressed to the user terminal 20-3 is multiplexed with the data D1 addressed to the user terminal 20-1, the data D2 addressed to the user terminal 20-2, and the data D3 addressed to the user terminal 20-3. Additionally, the wireless communication unit 12 subjects a reception signal received via the antenna 11 to down-conversion, analog-to-digital conversion, and other types of processing and outputs a base band reception signal thereby acquired to the BB processing unit 13.

Configuration of User Terminal

FIG. 5 is a functional block diagram illustrating the user terminal according to the first embodiment. In FIG. 5, the user terminal 20 includes antennas 211 and 221, a cellular communication unit 21, a D2D communication unit 22, and a communication control unit 23. The cellular communication unit 21 includes a wireless communication section 212 and a BB processing section 213. The D2D communication unit 22 includes a wireless communication section 222 and a BB processing section 223. The user terminal 20 is a D2D terminal.

In the cellular communication unit 21, the BB processing section 213 subjects a control message and data input from the communication control unit 23 to BB processing such as encoding and modulation, thereby generating a base band transmission signal and outputs the generated transmission signal to the wireless communication section 212. The BB processing section 213 subjects a base band reception signal input from the wireless communication section 212 to BB processing such as demodulation and decoding, thereby acquiring a control message and data and outputs the control message and data to the communication control unit 23.

The wireless communication section 212 subjects the base band transmission signal input from the BB processing section 213 to digital-to-analog conversion, up-conversion, and other types of processing and transmits the up-converted transmission signal to the base station 10 via the antenna 221 through a predetermined channel for cellular communication. Additionally, the wireless communication section 212 subjects a reception signal received from the base station 10 via the antenna 211 through the predetermined channel for cellular communication to down-conversion, analog-to-digital conversion, and other types of processing and outputs a base band reception signal thereby acquired to the BB processing section 213.

In the D2D communication unit 22, the BB processing section 223 subjects a control message and data input from the communication control unit 23 to BB processing such as encoding and modulation, thereby generating a base band transmission signal and outputs the generated transmission signal to the wireless communication section 222. The BB processing section 223 subjects a base band reception signal input from the wireless communication section 222 to BB processing such as demodulation and decoding, thereby acquiring a control message and data and outputs the control message and data to the communication control unit 23.

The wireless communication section 222 subjects the base band transmission signal input from the BB processing section 223 to digital-to-analog conversion, up-conversion, and other types of processing and transmits the up-converted transmission signal to another user terminal via the antenna 221 through a predetermined channel for D2D communication. Additionally, the wireless communication section 222 subjects a reception signal received from another user terminal via the antenna 211 through the predetermined channel for D2D communication to down-conversion, analog-to-digital conversion, and other types of processing and outputs a base band reception signal thereby acquired to the BB processing section 223.

The communication control unit 23 creates various types of control messages and outputs the control messages to the BB processing section 213 or the BB processing section 223. The communication control unit 23 also outputs data to the BB processing section 213 or the BB processing section 223. The communication control unit 23 acquires data addressed to the host terminal out of the data input from the BB processing section 213 or the BB processing section 223.

In the state illustrated in FIG. 2, for example, the data D1 and the data D2 are input from the BB processing section 213 to the communication control unit 23 in the user terminal 20-2. The communication control unit 23 of the user terminal 20-2, while acquiring the data D2 addressed to the host terminal out of the data D1 and the data D2, outputs the data D1 addressed to the user terminal 20-1 to the BB processing section 223. The data D1 addressed to the user terminal 20-1 is thus relayed and transmitted by the user terminal 20-2.

Alternatively, in the state illustrated in FIG. 3, for example, the data D1, the data D2, and the data D3 are input from the BB processing section 213 to the communication control unit 23 in the user terminal 20-3. The communication control unit 23 of the user terminal 20-3, while acquiring the data D3 addressed to the host terminal out of the data D1, the data D2, and the data D3, outputs the data D1 addressed to the user terminal 20-1 and the data D2 addressed to the user terminal 20-2 to the BB processing section 223. The data D1 addressed to the user terminal 20-1 and the data D2 addressed to the user terminal 20-2 are thus relayed and transmitted by the user terminal 20-3.

Processing Performed at Base Station

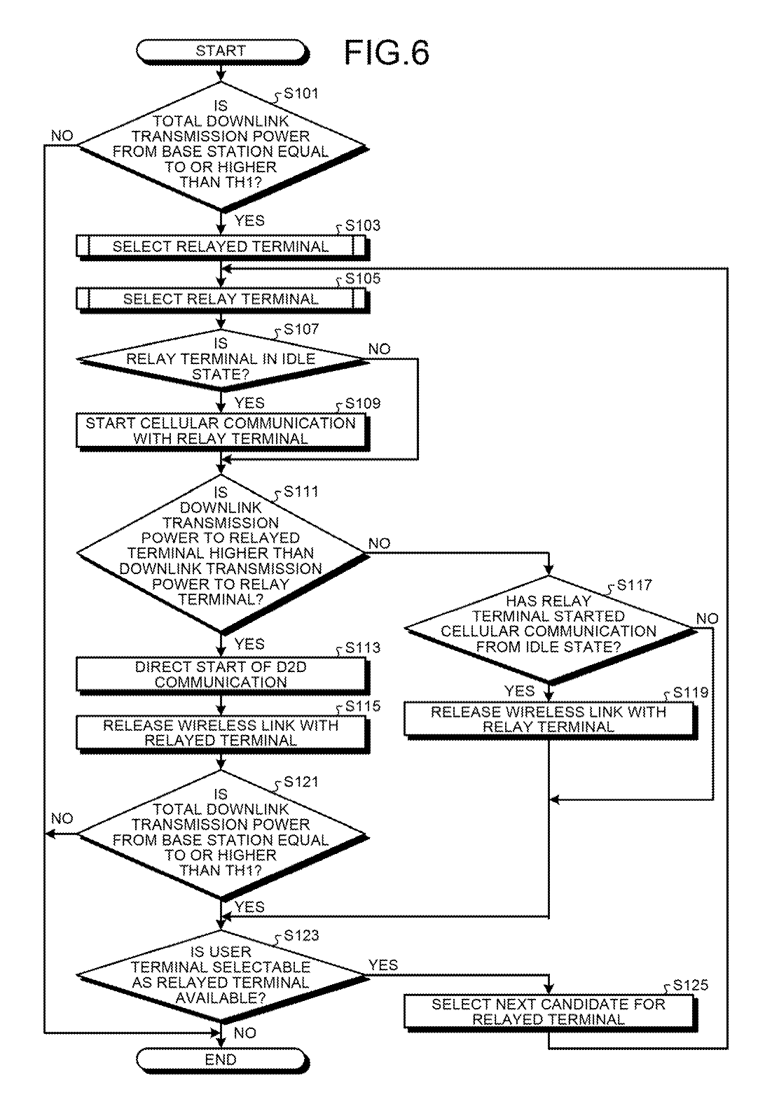

FIG. 6 is a flowchart for illustrating processing performed at the base station. The flowchart illustrated in FIG. 6 is started when the base station 10 starts communication with a new user terminal or at predetermined intervals.

In FIG. 6, the communication control unit 14 first determines whether the total downlink transmission power from the base station 10 is equal to or higher than the threshold TH1 (Step S101). The monitoring unit 15 constantly monitors the total downlink transmission power from the base station 10.

If the total downlink transmission power from the base station 10 is lower than the threshold TH1 (No at Step S101), the process is terminated.

If the total downlink transmission power from the base station 10 is equal to or higher than the threshold TH1 (Yes at Step S101), the communication control unit 14 selects a “relayed terminal” (Step S103). The term “relayed terminal” as used herein refers to a user terminal that receives data addressed to the host terminal via another user terminal through relaying in the D2D communication. For example, in the state illustrated in FIG. 2, the user terminal 20-1 corresponds to the relayed terminal. A process for selecting the relayed terminal will be described in detail later.

The communication control unit 14 selects a “relay terminal” (Step S105). The term “relay terminal” as used herein refers to a user terminal that relays to transmit data addressed to another user terminal through the D2D communication. For example, in the state illustrated in FIG. 2, the user terminal 20-2 corresponds to the relay terminal. A process for selecting the relay terminal will be described in detail later.

The communication control unit 14 determines whether the relay terminal is in an idle state (Step S107).

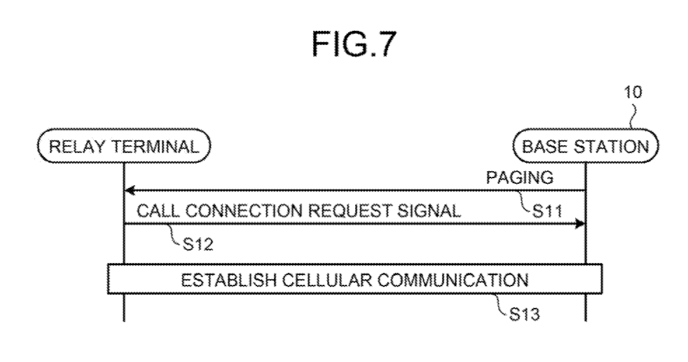

If the relay terminal is in the idle state (Yes at Step S107), the communication control unit 14 starts cellular communication with the relay terminal (Step S109). The cellular communication between the base station 10 and the relay terminal is started in accordance with, for example, FIG. 7. FIG. 7 is a diagram illustrating a processing sequence performed by the communication system according to the first embodiment. In FIG. 7, the base station 10 transmits a paging signal to the relay terminal (Step S11). The relay terminal, upon receipt of the paging signal, transmits a call connection request signal to the base station 10 (Step S12). The performance of Step S12 establishes and starts the cellular communication between the base station 10 and the relay terminal (Step S13).

If the relay terminal is not in the idle state (No at Step S107), that is, when cellular communication with the relay terminal has already been started, Step S109 is not performed and, instead, the process proceeds to Step S111.

The communication control unit 14 determines whether the downlink transmission power to the relayed terminal is higher than the downlink transmission power to the relay terminal (Step S111). The monitoring unit 15 constantly monitors the total downlink transmission power to each user terminal. If the downlink transmission power to the relayed terminal is higher than the downlink transmission power to the relay terminal (Yes at Step S111), the process proceeds to Step S113. If the downlink transmission power to the relayed terminal is equal to or lower than the downlink transmission power to the relay terminal (No at Step S111), the process proceeds to Step S117.

At Step S117, the communication control unit 14 determines whether the relay terminal has started the cellular communication from the idle state. Specifically, at Step S117, the communication control unit 14 determines whether Step S109 has been performed. If Step S109 has been performed (Yes at Step S117), the communication control unit 14 releases a wireless link between the base station 10 and the relay terminal (Step S119). If Step S109 has not been performed (No at Step S117), Step S117 is not performed and, instead, the process proceeds to Step S123.

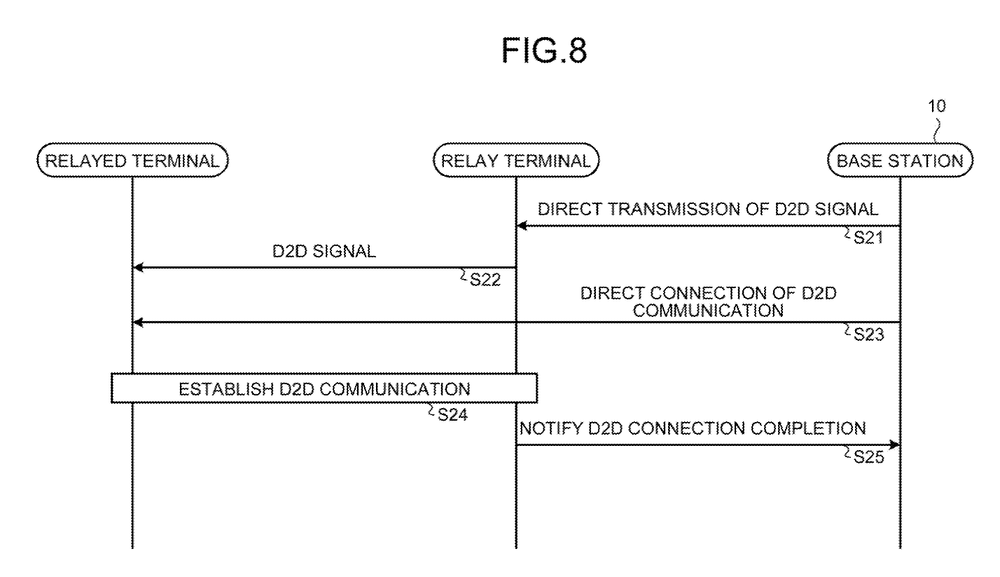

At Step S113, the communication control unit 14 directs the relayed terminal and the relay terminal to start D2D communication. This direction starts D2D communication between the relayed terminal and the relay terminal. The D2D communication between the relayed terminal and the relay terminal is started in accordance with, for example, FIG. 8. FIG. 8 is a diagram illustrating a processing sequence performed by the communication system according to the first embodiment. In FIG. 8, the base station 10 directs the relay terminal to transmit a D2D signal (Step S21). In response to the direction at Step S21, the relay terminal transmits the D2D signal that includes a terminal ID of the relay terminal to the relayed terminal (Step S22). Additionally, the base station 10 directs the relayed terminal to connect the D2D communication with the relay terminal (Step S23). In response to the direction at Step S23, the relayed terminal establishes the D2D communication with the relay terminal using the terminal ID included in the D2D signal (Step S24). The establishment of the D2D communication starts the D2D communication between the relay terminal and the relayed terminal. The relay terminal next transmits a D2D connection completion notification to the base station 10 (Step S25).

The communication control unit 14 releases the wireless link between the base station 10 and the relayed terminal (Step S115).

The communication control unit 14 determines whether the total downlink transmission power from the base station 10 is equal to or higher than the threshold TH1 (Step S121).

If the total downlink transmission power from the base station 10 is lower than the threshold TH1 (No at Step S121), the process is terminated.

If the total downlink transmission power from the base station 10 is equal to or higher than the threshold TH1 (Yes at Step S121), the process proceeds to Step S123.

At Step S123, the communication control unit 14 determines whether a user terminal that can be selected as a relayed terminal is available, specifically, whether a candidate for the relayed terminal is available (Step S123). If a user terminal selectable as a relayed terminal is not available, specifically, if a candidate for the relayed terminal is no longer available (No at Step S123), the process is terminated.

If a user terminal selectable as a relayed terminal is available, specifically, if a candidate for the relayed terminal is available (Yes at Step S123), the communication control unit 14 selects a next candidate for the relayed terminal (Step S125). After Step S125, the process returns to Step S105 and the steps from Step S105 onward are repeated.

Processing to Select Relayed Terminal

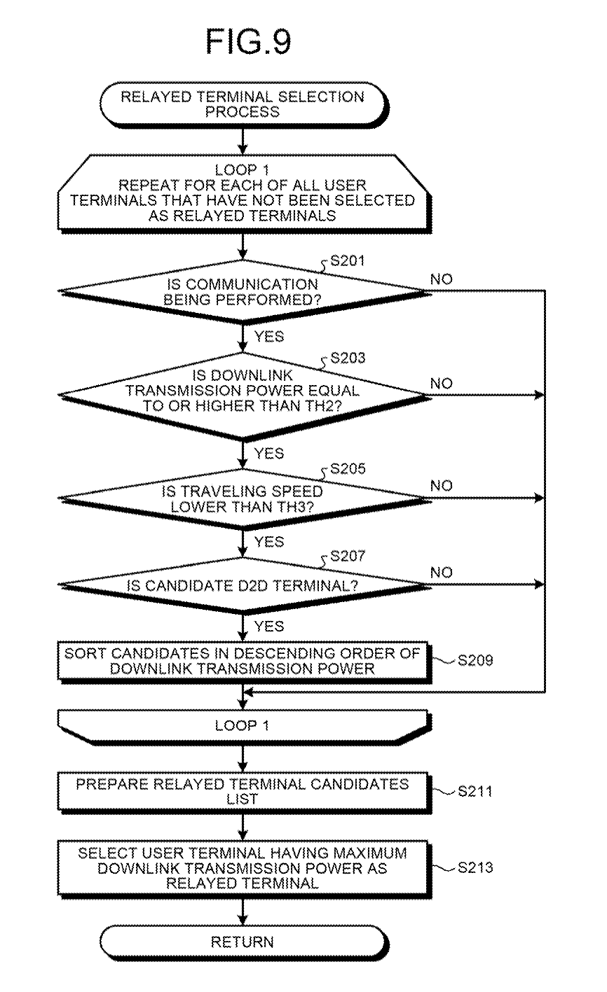

FIG. 9 is a flowchart for illustrating a relayed terminal selection process according to the first embodiment.

The communication control unit 14 repeats the steps from Step S201 to Step S209 under conditions of loop 1. Specifically, the communication control unit 14 repeats the steps from Step S201 to Step S209 for each of all user terminals that have not been selected as relayed terminals (loop 1).

The communication control unit 14 first determines whether the user terminal as a candidate for the relayed terminal (hereinafter may be referred to as a “relayed terminal candidate”) is communicating with the base station 10 (specifically, whether the relayed terminal candidate is not in the idle state) (Step S201). The monitoring unit 15 monitors a communication state of each of all user terminals located within the cell C1 to acquire various types of information indicating the communication state. The various types of information acquired by the monitoring unit 15 are input to the communication control unit 14. Examples of the information indicating the communication state of each user terminal include communication start time, communication end time, downlink transmission power from the base station 10, position when starting communication, position when ending communication, traffic during communication, and traveling speed. If, for example, both of the communication start time and the communication end time after the communication start time are acquired, the communication control unit 14 determines that the relayed terminal candidate is not communicating. If, for example, only the communication start time is acquired, the communication control unit 14 determines that the relayed terminal candidate is communicating. If the relayed terminal candidate is not communicating (No at Step S201), the loop 1 is performed for a subsequent relayed terminal candidate.

If the relayed terminal candidate is communicating (Yes at Step S201), the communication control unit 14 determines whether the downlink transmission power to the relayed terminal candidate is equal to or higher than a threshold TH2 (Step S203). If the downlink transmission power to the relayed terminal candidate is lower than the threshold TH2 (No at Step S203), the loop 1 is performed for a subsequent relayed terminal candidate.

If the downlink transmission power to the relayed terminal candidate is equal to or higher than the threshold TH2 (Yes at Step S203), the communication control unit 14 determines whether the traveling speed of the relayed terminal candidate is lower than a threshold TH3 (Step 3205). If the traveling speed of the relayed terminal candidate is equal to or higher than the threshold TH3 (No at Step S205), the loop 1 is performed for a subsequent relayed terminal candidate.

If the traveling speed of the relayed terminal candidate is lower than the threshold TH3 (Yes at Step S205), the communication control unit 14 determines whether the relayed terminal candidate is a D2D terminal (Step S207). Information that indicates whether each user terminal is a D2D terminal is stored in advance in the information storage unit 16 by, for example, a communication service provider. If the relayed terminal candidate is not a D2D terminal, specifically, if the relayed terminal candidate is a cellular terminal (No at Step S207), the loop 1 is performed for a subsequent relayed terminal candidate.

If the relayed terminal candidate is a D2D terminal (Yes at Step S207), the communication control unit 14 sorts relayed terminal candidates that satisfy the conditions of the steps from Step S201 to Step S207 in descending order of the downlink transmission power (Step S209). After the sorting, the loop 1 is performed for the subsequent relayed terminal candidate.

The communication control unit 14, when having exited from the repeating sequence of the loop 1, prepares a list of a result of the sorting at Step S209, specifically, a sorted list of relayed terminal candidates (may be referred to in the following as a “relayed terminal candidates list”) (Step S211). The communication control unit 14 selects as the relayed terminal a specific user terminal that occupies the top position in the sorting at Step S209, specifically, that satisfies all of the conditions of the steps from Step S201 to Step S207 and that has maximum downlink transmission power (Step S213). After Step S213, the process proceeds to Step S105 (FIG. 6).

It is noted that, out of the two condition determinations of Step S203 and Step S205 in FIG. 9, only either one of the two may be employed. Which one of the condition determinations is to be employed is determined by, for example, a communication service provider.

Processing to Select Relay Terminal

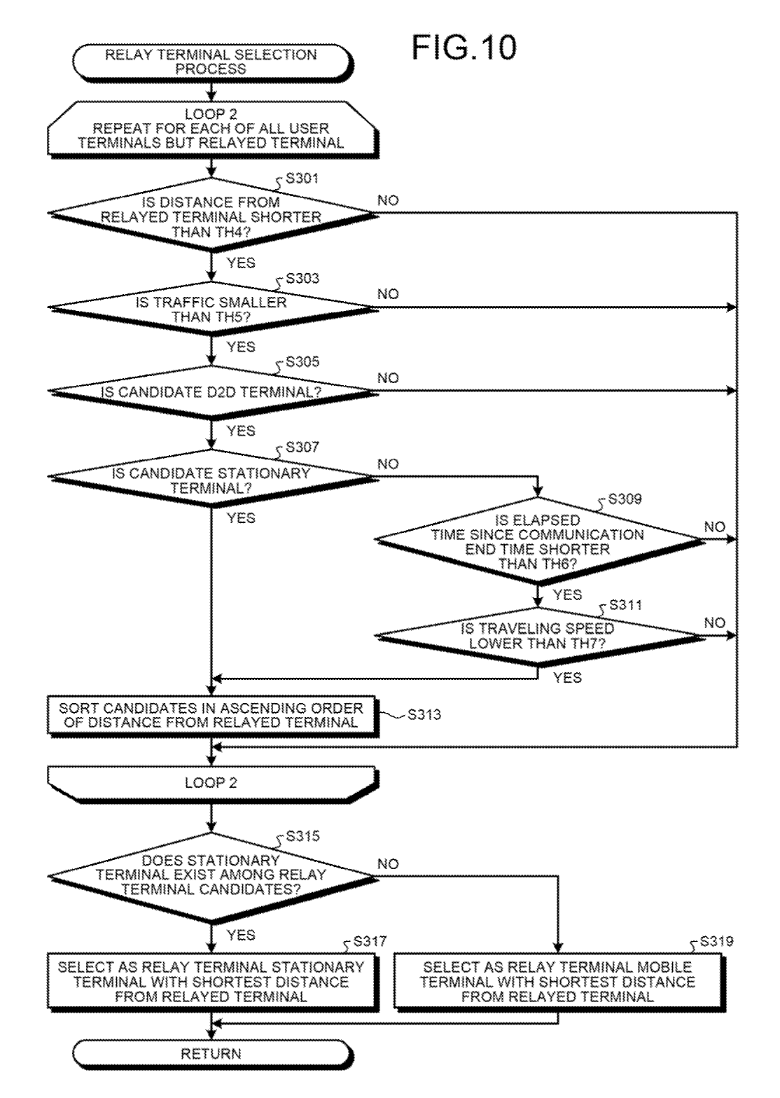

FIG. 10 is a flowchart for illustrating a relay terminal selection process according to the first embodiment.

The communication control unit 14 repeats steps from Step S301 to Step S313 under conditions of loop 2. Specifically, the communication control unit 14 repeats the steps from Step S301 to Step S313 for each of all user terminals but the relayed terminals (loop 2).

The communication control unit 14 first determines whether a distance between the user terminal as a candidate for the relay terminal (hereinafter may be referred to as a “relay terminal candidate”) and the relayed terminal selected at Step S103 (FIG. 6) is shorter than a threshold TH4 (Step S301). The threshold TH4 is set to an upper limit distance value over which D2D communication can be performed between the D2D terminals. Specifically, Step S301 determines whether the relay terminal candidate is located within a range in which communication can be performed with the relayed terminal. If the distance between the relay terminal candidate and the relayed terminal is equal to or longer than the threshold TH4 (No at Step S301), the loop 2 is performed for a subsequent relay terminal candidate.

If the distance between the relay terminal candidate and the relayed terminal is shorter than the threshold TH4 (Yes at Step S301), the communication control unit 14 determines whether traffic of the communication being performed by the relay terminal candidate is smaller than a threshold TH5 (Step S303). If the traffic of the communication being performed by the relay terminal candidate is equal to or greater than the threshold TH5 (No at Step S303), the loop 2 is performed for a subsequent relay terminal candidate.

If the traffic of the communication being performed by the relay terminal candidate is smaller than the threshold TH5 (Yes at Step S303), the communication control unit 14 determines whether the relay terminal candidate is a D2D terminal (Step S305). If the relay terminal candidate is not a D2D terminal, specifically, if the relay terminal candidate is a cellular terminal (No at Step S305), the loop 2 is performed for a subsequent relay terminal candidate.

If the relay terminal candidate is a D2D terminal (Yes at Step S305), the communication control unit 14 determines whether the relay terminal candidate is a “stationary terminal” (Step S307).

It is here noted that introduction of machine type communication (MTC) terminals as a new type of user terminal is being studied. Examples of the MTC terminals include a smart meter as a wattmeter having a wireless communication function and a vending machine having a wireless communication function. In this connection, the “stationary terminal” is a stationary user terminal that may, for example, be a smart meter and corresponds to the MTC terminal. In the following, portable phones, smartphones, tablet terminals, and other movable user terminals may be referred to as “mobile terminals”. Information that indicates whether each user terminal is a stationary terminal is stored in advance in the information storage unit 16 by a communication service provider. Additionally, some stationary terminals are capable of D2D communication, while others are not capable of D2D communication.

If the relay terminal candidate is not a stationary terminal, specifically, if the relay terminal candidate is a mobile terminal (No at Step S307), the communication control unit 14 determines whether an elapsed time since a time at which the communication between the relay terminal candidate and the base station 10 ended is shorter than a threshold TH6 (Step S309). If the relay terminal candidate is a stationary terminal (Yes at Step S307), steps of Step S309 and Step S311 are not performed and, instead, the process proceeds to Step S313.

If the elapsed time since the communication end time is equal to or longer than the threshold TH6 (No at Step S309), the loop 2 is performed for a subsequent relay terminal candidate.

If the elapsed time since the communication end time is shorter than the threshold TH6 (Yes at Step S309), the communication control unit 14 determines whether the traveling speed of the relay terminal candidate is lower than a threshold TH7 (Step S311). If the traveling speed of the relay terminal candidate is equal to or higher than the threshold TH7 (No at Step S311), the loop 2 is performed for a subsequent relayed terminal candidate. If the traveling speed of the relayed terminal candidate is lower than the threshold TH7 (Yes at Step S311), the process proceeds to Step S313.

At Step S313, the communication control unit 14 sorts relay terminal candidates that satisfy the conditions of the steps from Step S301 to Step S307 and relay terminal candidates that satisfy the conditions of the steps from Step S301 to Step S305, of Step S309, and of Step S311 in ascending order of a distance from the relayed terminal (Step S313). After the sorting, the loop 2 is performed for the subsequent relay terminal candidate.

The communication control unit 14, when having exited from the repeating sequence of the loop 2, determines whether a stationary terminal exists among the relay terminal candidates after the sorting at Step S313 (Step S315).

If a stationary terminal exists among the relay terminal candidates after the sorting at Step S313 (Yes at Step S315), the communication control unit 14 selects as the relay terminal a stationary terminal that occupies the top position in the sorting, specifically, that satisfies all of the conditions of the steps from Step S301 to Step S307 and that has the shortest distance from the relayed terminal (Step S317). After Step S317, the process proceeds to Step S107 (FIG. 6).

If no stationary terminal exists among the relay terminal candidates after the sorting at Step S313 (No at Step S315), the communication control unit 14 selects as the relay terminal a mobile terminal that occupies the top position in the sorting, specifically, that satisfies all of the conditions of the steps from Step S301 to Step S305, Step S309, and Step S311 and that has the shortest distance from the relayed terminal (Step S319). After Step S319, the process proceeds to Step S107 (FIG. 6).

It is noted that, out of the four condition determinations of Step S303, Step S307, Step S309, and Step S311 in FIG. 10, only one, two, or three of the four may be employed. Which one or ones of the condition determinations are to be employed is determined by, for example, a communication service provider.

Specific Example of Selection Processes

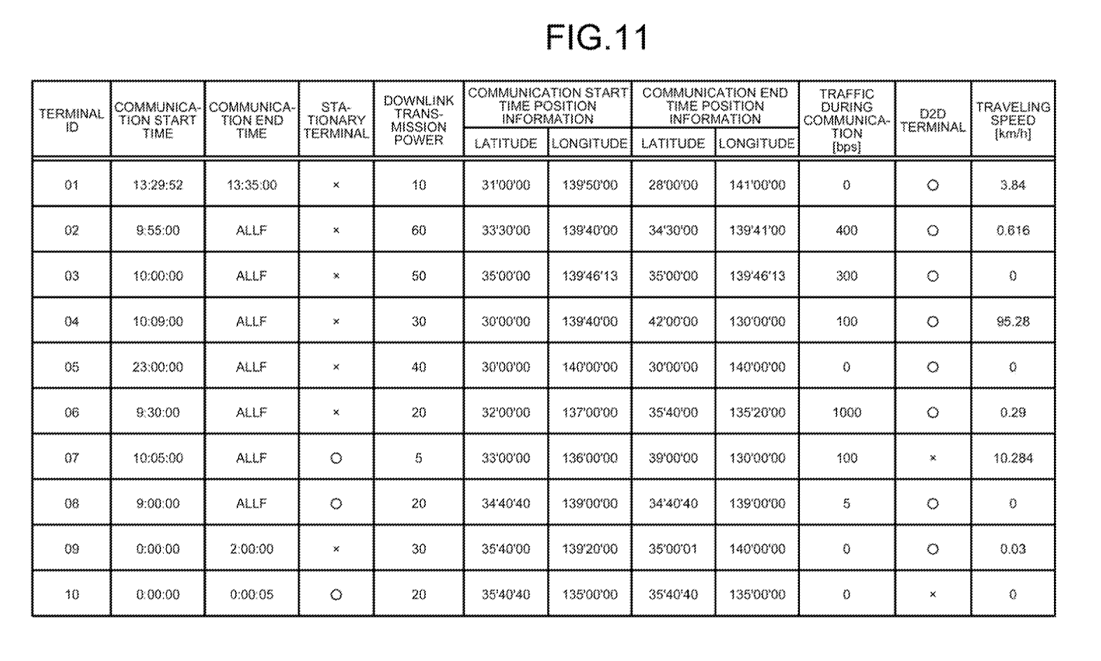

The following describes specific examples of the processes for selecting the relayed terminal and the relay terminal. FIGS. 11 to 14 are tables for illustrating specific examples of the selection processes according to the first embodiment.

As illustrated in FIG. 11, the communication control unit 14 has previously identified information on each of different items for each of user terminals identified by terminal IDs of 01 to 10. The information represents data monitored by the monitoring unit 15 or stored in the information storage unit 16. In FIG. 11, the “communication start time” and the “communication end time” are depicted by the format of “HH:MM:SS”. “ALLF” depicted under the “communication end time” denotes that the communication with the base station 10 is yet to be completed, specifically, the user terminal is communicating with the base station 10. In the item of “stationary terminal.”, “∘” denotes that the user terminal is a stationary terminal and “x” denotes that the user terminal is a mobile terminal. In the item of “D2D terminal”, “∘” denotes that the user terminal is a D2D terminal and “x” denotes that the user terminal is a cellular terminal. “Communication end time position information” indicates the position at the end of the last communication session. “Traveling speed” is calculated using values of “communication start time position information”, “communication end time position information”, and “communication start time”, and the current time.

In accordance with the flowchart illustrated in FIG. 9, the communication control unit 14 selects a relayed terminal. Exemplarily, assume that the threshold TH2 is “25” and the threshold TH3 is “10 km/h” in FIG. 9.

Thus, in FIG. 11, the user terminals that satisfy the condition of Step S201 in FIG. 9 are user terminals identified by terminal IDs of 02 to 08.

The user terminals that satisfy the condition of Step S203 are user terminals identified by terminal IDs of 02 to 05 out of the user terminals identified by terminal IDs of 02 to 08.

The user terminals that satisfy the condition of Step S205 are user terminals identified by terminal IDs of 02, 03, and 05 out of the user terminals identified by terminal IDs of 02 to 05.

The user terminals identified by terminal IDs of 02, 03, and 05, each of which is a D2D terminal, satisfy the condition of Step S207.

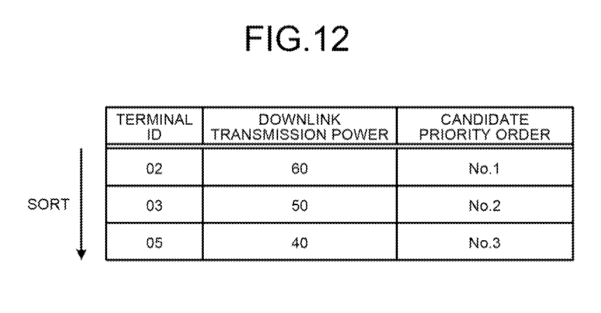

The sorting performed at Step S209 yields a relayed terminal candidates list, and the relayed terminal candidates list at Step S211 looks like as illustrated in FIG. 12.

Thus, the communication control unit 14 selects, at Step S213, the user terminal identified by a terminal ID of 02 as the relayed terminal. The user terminal identified by the terminal ID of 02 selected as the relayed terminal is, for example, the user terminal 20-1 in FIG. 2.

The communication control unit 14 next selects a relay terminal in accordance with the flowchart illustrated in FIG. 10. Exemplarily, assume that the threshold TH4 is “100 m”, the threshold TH5 is “10 bps”, the threshold TH6 is “3600 seconds”, and the threshold TH7 is “10 km/h” in FIG. 10. The current time (HH:MM:SS) is “2:45:00”.

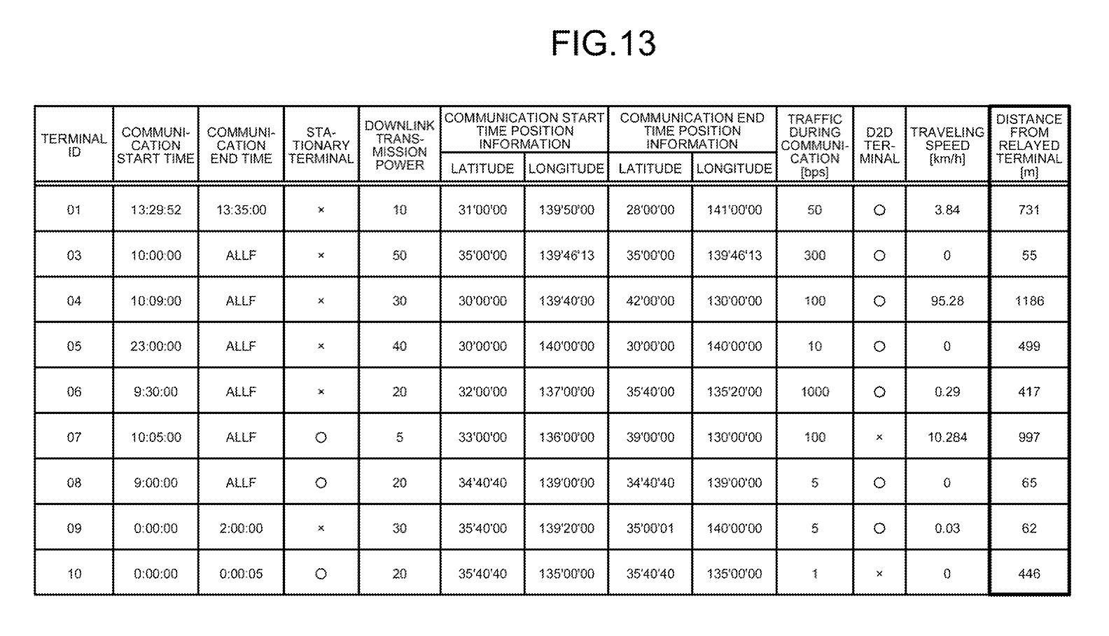

At Step S301, the communication control unit 14 calculates, for each of all user terminals but the user terminal identified by the terminal ID of 02 (specifically, the relayed terminal), the distance from the user terminal identified by the terminal ID of 02. FIG. 13 depicts results of the calculations.

Thus, in FIG. 13, the user terminals that satisfy the condition of Step S301 are the user terminals identified by the terminal IDs of 03, 08, and 09.

Additionally, the user terminals that satisfy the condition of Step S303 are, out of the user terminals identified by the terminal IDs of 03, 08, and 09, the user terminals identified by the terminal IDs of 08 and 09.

The user terminals identified by the terminal IDs of 08 and 09 are each a D2D terminal and thus each satisfy the condition of Step S305.

The user terminal identified by the terminal ID of 08 is a stationary terminal (Yes at Step S307) and the user terminal identified by the terminal ID of 09 is a mobile terminal (No at Step S307).

Furthermore, the user terminal identified by the terminal ID of 09 satisfies the conditions of both Step S309 and Step S311.

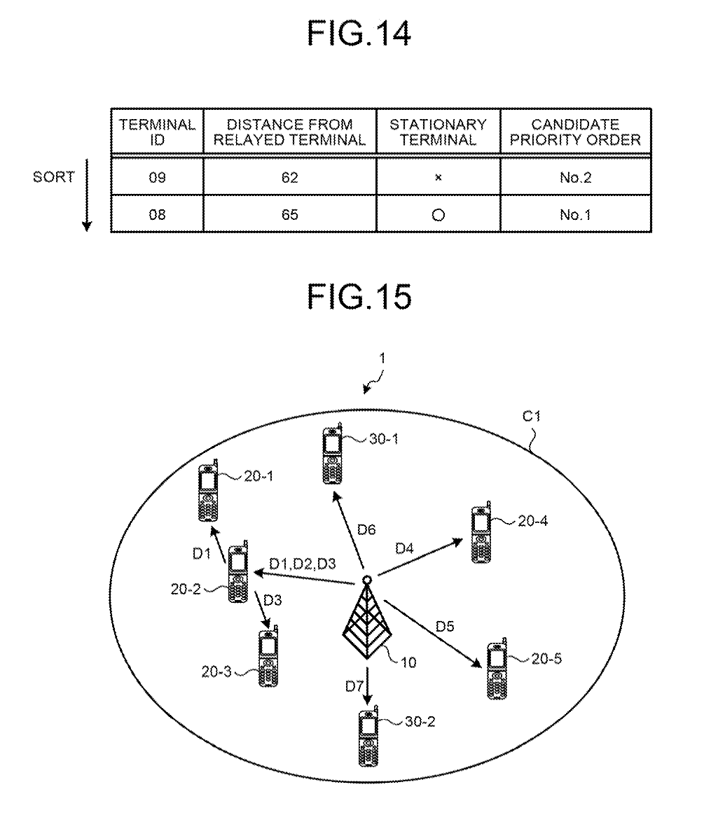

Thus, the performance of sorting at Step S313 yields a result that looks like as illustrated in FIG. 14.

Of the user terminals identified by the terminal IDs of 08 and 09, the user terminal identified by the terminal ID of 08 is a stationary terminal, so that Step S315 is determined to be “Yes”. The communication control unit 14 thus selects the user terminal identified by the terminal ID of 08 as the relay terminal at Step S317. The user terminal identified by the terminal ID of 08 selected as the relay terminal is, for example, the user terminal 20-2 in FIG. 2.

As described above, in the first embodiment, the base station 10 having an upper limit of the total downlink transmission power includes the monitoring unit 15 and the communication control unit 14. The monitoring unit 15 monitors the total downlink transmission power from the base station 10. When the total downlink transmission power from the base station 10 is equal to or higher than the threshold TH1, the communication control unit 14 changes the transmission destination of the data D1 addressed to the user terminal 20-1 from the user terminal 20-1 to the user terminal 20-2. The user terminal 20-2 is capable of direct communication with the user terminal 20-1 without requiring the base station 10 therebetween. Specifically, the user terminal 20-2 is capable of D2D communication with the user terminal 20-1.

The foregoing process results in the user terminal 20-2 relaying to transmit the data D1 to the user terminal 20-1.

The downlink transmission power to the user terminal 20-2 is lower than the downlink transmission power to the user terminal 20-1.

The first embodiment thus eliminates the transmission from the base station 10 to the user terminal 20-1, so that the total downlink transmission power from the base station 10 is reduced by the amount of the downlink transmission power to the user terminal 20-1. This adds to a margin for the total downlink transmission power from the base station 10, so that the system capacity can be prevented from being reduced.

The communication control unit 14 selects as the relayed terminal a user terminal having the downlink transmission power from the base station 10 equal to or higher than the threshold TH2.

This selection allows a reduction in the total downlink transmission power from the base station 10 to be increased, so that prevention of reduction in the system capacity can be enhanced.

The communication control unit 14 selects as the relayed terminal a user terminal having the traveling speed lower than the threshold TH3.

This arrangement allows user terminals that are highly likely to continue staying within the cell C1 in the future to be the relayed terminals. The total downlink transmission power from the base station 10 can thereby be reliably reduced. Specifically, an optimum user terminal can be selected as the relayed terminal.

The communication control unit 14 selects as the relay terminal a user terminal having the traffic smaller than the threshold TH5.

This arrangement allows a user terminal having a margin in the traffic, specifically, a user terminal that is less likely to cause deterioration in the throughput of the host terminal as a result of its serving as a relay terminal, to be a relay terminal. As a result, relay transmission to the relayed terminal through the relay terminal can be performed without affecting communication of the user terminal that serves as the relay terminal.

The communication control unit 14 selects as the relay terminal a user terminal having the elapsed time since the end of communication shorter than the threshold TH6.

This arrangement allows user terminals that are highly likely to continue staying within the cell C1 in the future to be the relay terminals, so that the total downlink transmission power once reduced can be prevented from increasing again.

The communication control unit 14 selects as the relay terminal a user terminal having the traveling speed lower than the threshold.

This arrangement allows user terminals that are highly likely to continue staying within the cell C1 in the future to be the relay terminals, so that the total downlink transmission power once reduced can be prevented from increasing again.

The communication control unit 14 selects a stationary terminal as the relay terminal.

This arrangement allows relay transmission to the relayed terminal through the relay terminal to be performed without affecting communication of a mobile terminal.

### [b] Second Embodiment

### Configuration of Communication System

FIG. 15 is a diagram illustrating a communication system according to a second embodiment. FIG. 15 illustrates a state shifted from the state illustrated in FIG. 2.

Specifically, when the total downlink transmission power of the base station 10 remains equal to or higher than the threshold TH1 even after the transmission destination of the data D1 addressed to the user terminal 20-1 has been changed from the user terminal 20-1 to the user terminal 20-2 as illustrated in FIG. 2, the communication system 1 shifts from the state illustrated in FIG. 2 to the state illustrated in FIG. 15, for example. Specifically, in FIG. 15, the transmission destination of the data D3 addressed to the user terminal 20-3 is, from the state illustrated in FIG. 2, further changed from the user terminal 20-3 to the user terminal 20-2 and the data D3 addressed to the user terminal 20-3 is transmitted to the user terminal 20-3 through the user terminal 20-2. The user terminal 20-3, because being located close to the user terminal 20-2, is capable of D2D communication with the user terminal 20-2. Thus, the shift of the communication system 1 from the state illustrated in FIG. 2 to the state illustrated in FIG. 15 further eliminates the need for transmission from the base station 10 to the user terminal 20-3, so that the total downlink transmission power from the base station 10 is reduced further by the amount of the downlink transmission power to the user terminal 20-3. The shift of the communication system 1 from the state illustrated in FIG. 2 to the state illustrated in FIG. 15 results in the communication system 1 maintaining the state illustrated in FIG. 15 as long as the total downlink transmission power of the base station 10 that has fallen below the threshold TH1 remains lower than the threshold TH1.

Configuration of Base Station

The base station in the second embodiment is configured in the same manner as the base station in the first embodiment (FIG. 4) and descriptions thereof will be omitted.

Configuration of User Terminal

The user terminal in the second embodiment is configured in the same manner as the D2D terminal in the first embodiment (FIG. 5) and descriptions thereof will be omitted.

Processing Performed at Base Station

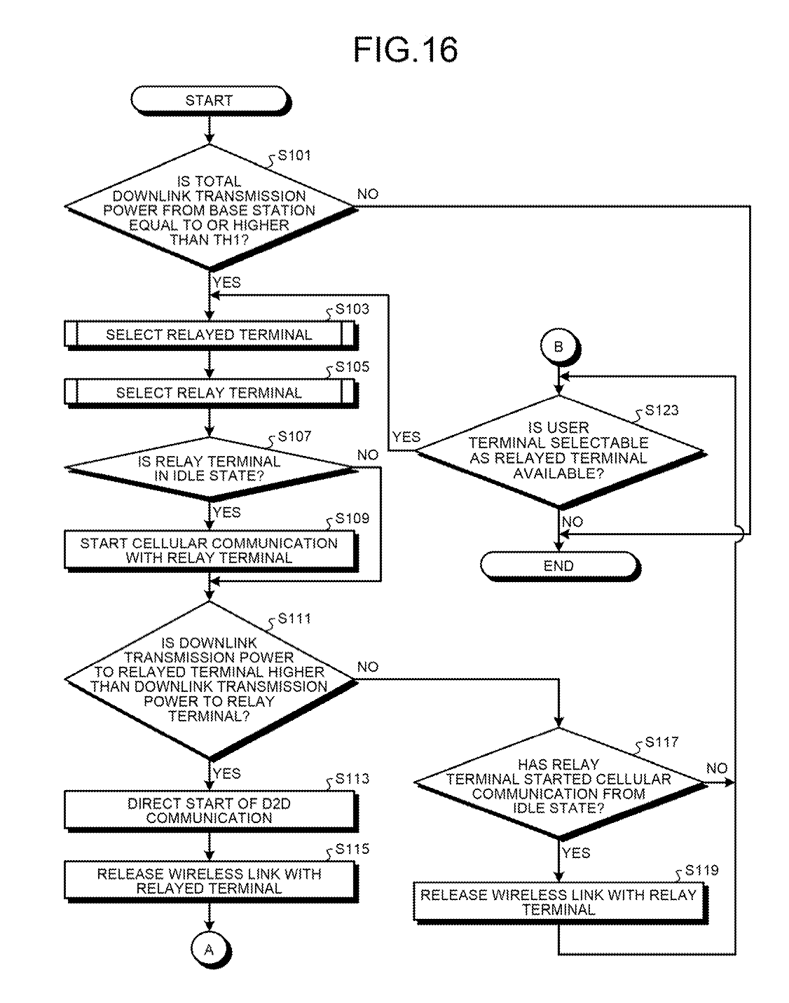

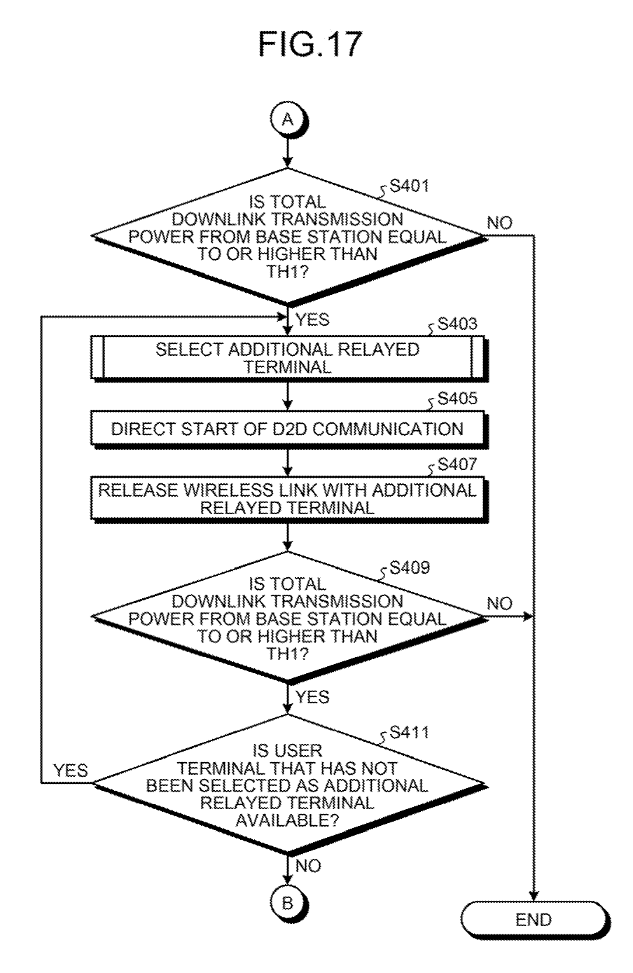

FIGS. 16 and 17 are flowcharts for illustrating processing performed at the base station in the second embodiment. The flowcharts illustrated in FIGS. 16 and 17 are started when the base station 10 starts communication with a new user terminal or at predetermined intervals.

In FIGS. 16 and 17, the steps from Step S101 to Step S119 are the same as those in the first embodiment (FIG. 6) and descriptions thereof will be omitted.

After Step S115, the communication control unit 14 determines whether the total downlink transmission power from the base station 10 is equal to or higher than the threshold TH1 (Step S401). If the total downlink transmission power from the base station 10 is lower than the threshold TH1 (No at Step S401), the process is terminated.

If the total downlink transmission power from the base station 10 is equal to or higher than the threshold TH1 (Yes at Step S401), the communication control unit 14 selects an “additional relayed terminal” (Step S403). The term “additional relayed terminal” as used herein refers to a user terminal selected as a second or subsequent relayed terminal from among a plurality of user terminals that receive, through relaying in the D2D communication, data addressed to respective host terminals via another user terminal that serves as a relay terminal for each of these user terminals. For example, in the state illustrated in FIG. 15, the user terminal 20-3 corresponds to the additional relayed terminal. A process for selecting the additional relayed terminal will be described in detail later.

The communication control unit 14 directs the additional relayed terminal and the relay terminal to start D2D communication (Step S405). This direction starts the D2D communication between the additional relayed terminal and the relay terminal. The D2D communication between the additional relayed terminal and the relay terminal is started in accordance with, for example, FIG. 8, as in the D2D communication between the relayed terminal and the relay terminal.

The communication control unit 14 releases the wireless link between the base station 10 and the additional relayed terminal (Step S407).

The communication control unit 14 determines whether the total downlink transmission power from the base station 10 is equal to or higher than the threshold TH1 (Step S409). If the total downlink transmission power from the base station 10 is lower than the threshold TH1 (No at Step S409), the process is terminated.

If the total downlink transmission power from the base station 10 is equal to or higher than the threshold TH1 (Yes at Step S409), the communication control unit 14 determines whether a user terminal that has not been selected as the additional relayed terminal through the step at Step S403 is available (Step S411). If a user terminal that has not been selected as the additional relayed terminal is available (Yes at Step S411), the process returns to Step S403. If a user terminal that has not been selected as the additional relayed terminal is not available (No at Step S411), the process proceeds to Step S123.

Processing to Select Additional Relayed Terminal

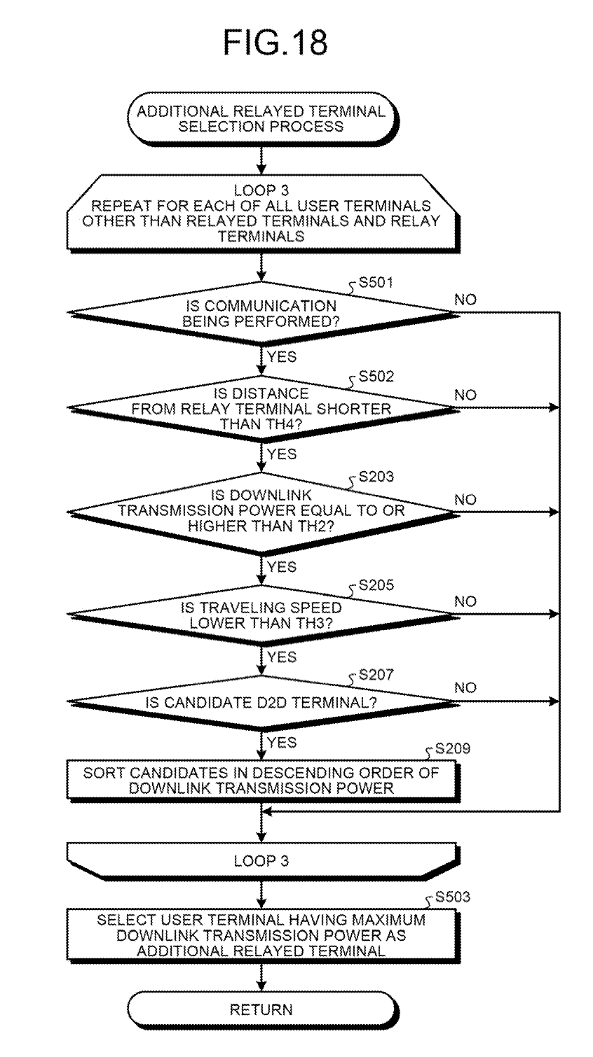

FIG. 18 is a flowchart for illustrating an additional relayed terminal selection process according to the second embodiment.

The communication control unit 14 repeats steps of Step S501, Step S502, and from Step S203 to Step S209 under conditions of loop 3. Specifically, the communication control unit 14 repeats the steps of Step S501, Step S502, and from Step S203 to Step S209 for each of all user terminals other than the relayed terminals and the relay terminals (loop 3). In FIG. 18, the steps from Step S203 to Step S209 are the same as those in FIG. 9 and descriptions thereof will be omitted.

The communication control unit 14 first determines whether the user terminal as a candidate for the additional relayed terminal (hereinafter may be referred to as an “additional relayed terminal candidate”) is communicating with the base station 10 (specifically, whether the additional relayed terminal candidate is not in the idle state) (Step S501). The method of making this determination is the same as that in the first embodiment. If the additional relayed terminal candidate is not communicating (No at Step S501), the loop 3 is performed for a subsequent additional relayed terminal candidate.

If the additional relayed terminal candidate is communicating (Yes at Step S501), the communication control unit 14 determines whether the distance between the additional relayed terminal candidate and the relay terminal selected at Step S105 (FIG. 6) is shorter than the threshold TH4 (Step S502). Specifically, at Step S502, the communication control unit 14 determines whether the additional relayed terminal candidate is located within a range in which communication can be performed with the relay terminal. If the distance between the additional relayed terminal candidate and the relay terminal is equal to or longer than the threshold TH4 (No at Step S502), the loop 3 is performed for a subsequent additional relayed terminal candidate. If the distance between the additional relayed terminal candidate and the relay terminal is shorter than the threshold TH4 (Yes at Step S502), the process proceeds to Step S203.

The communication control unit 14, when having exited from the repeating sequence of the loop 3, selects as the additional relayed terminal a specific user terminal that occupies the top position in the sorting at Step S209, specifically, a user terminal that satisfies all of the conditions of the steps of Step S501, Step S502, and from Step S203 to Step S207 and that has maximum downlink transmission power (Step S503). After Step S503, the process proceeds to Step S405 (FIG. 17).

It is noted that, out of the two condition determinations of Step S203 and Step S205 in FIG. 18, only either one of the two may be employed. Which one of the condition determinations is to be employed is determined by, for example, a communication service provider.

Specific Example of Selection Process

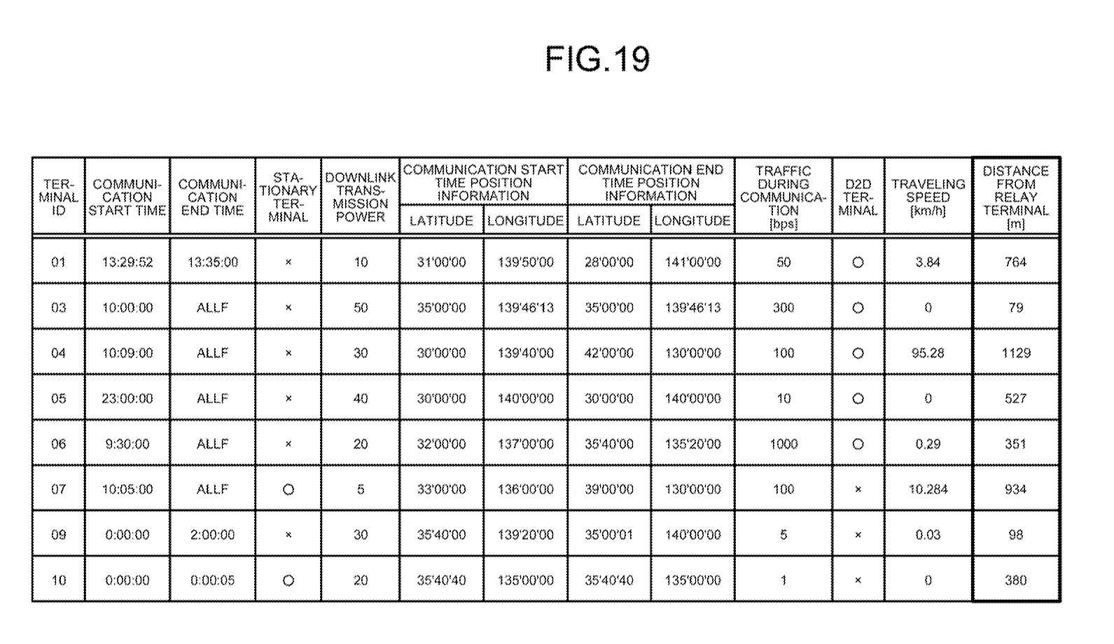

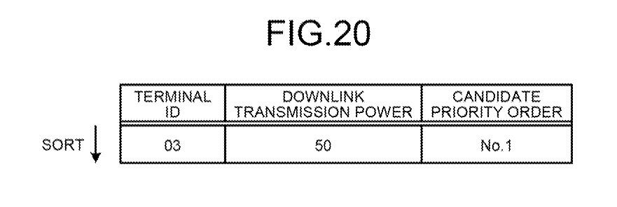

The following describes a specific example of the process for selecting the additional relayed terminal. FIGS. 19 and 20 are tables for illustrating the specific example of the selection process according to the second embodiment.

In accordance with the flowchart illustrated in FIG. 18, the communication control unit 14 selects an additional relayed terminal.

First, the communication control unit 14 determines, for each of all user terminals but the user terminal identified by the terminal ID of 02 (specifically, the relayed terminal) and the user terminal identified by the terminal ID of 08 (specifically, the relay terminal), whether the condition of Step S501 in FIG. 18 is satisfied. In FIG. 19, the user terminals that satisfy the condition of Step S501 in FIG. 18 are the user terminals identified by the terminal IDs of 03 to 07.

Then at Step S502 in FIG. 18, the communication control unit 14 calculates, for each of all user terminals but the user terminal identified by the terminal ID of 02 and the user terminal identified by the terminal ID of 08, the distance from the user terminal identified by the terminal ID of 08 (specifically, the relay terminal). FIG. 19 depicts results of the calculations.

In FIG. 19, the user terminal that satisfies the conditions of both Step S501 and Step S502 is the user terminal identified by the terminal ID of 03.

The user terminal identified by the terminal ID of 03 satisfies all of the conditions of Step S203 to Step S207.

Thus, the performance of sorting at Step S209 yields a result that looks like as illustrated in FIG. 20.

The communication control unit 14 then selects, at Step S503, the user terminal identified by the terminal ID of 03 as the additional relayed terminal. The user terminal identified by the terminal ID of 03 selected as the additional relayed terminal is, for example, the user terminal 20-3 in FIG. 15.

As described above, in the second embodiment, the communication control unit 14 changes, in addition to the user terminal 20-1, the transmission destination for the data D3 addressed to the user terminal 20-3 that is capable of D2D communication with the user terminal 20-2 from the user terminal 20-3 to the user terminal 20-2.

The second embodiment thus allows a single relay terminal to relay to transmit data to a plurality of relayed terminals, thereby preventing the number of relay terminals from increasing.

There is an upper limit to the number of wireless links to be established by a single base station. In the second embodiment, however, because the relay terminal is already communicating with the base station 10 when an additional relayed terminal is to be selected, no need exists to establish a new wireless link between the relay terminal and the base station 10 in order for the relay terminal to perform relay transmission to the additional relayed terminal. Thus, the second embodiment is suitable for a condition in which the number of wireless links to be established is tight. The communication control unit 14 may therefore, for example, determine in which state the communication system 1 is to shift from the state illustrated in FIG. 2, whether in the state illustrated in FIG. 3 or the state illustrated in FIG. 15, on the basis of the number of wireless links already established by the base station 10, after the user terminal 20-2 has been selected as the relay terminal for the user terminal 20-1 as illustrated in FIG. 2. For example, when the number of wireless links already established by the base station 10 is less than a predetermined threshold, the communication control unit 14 may opt to shift to the state illustrated in FIG. 3; when the number of wireless links already established by the base station 10 is equal to or greater than the predetermined threshold, the communication control unit 14 may opt to shift to the state illustrated in FIG. 15.

### [c] Third Embodiment

### Configuration of Communication System

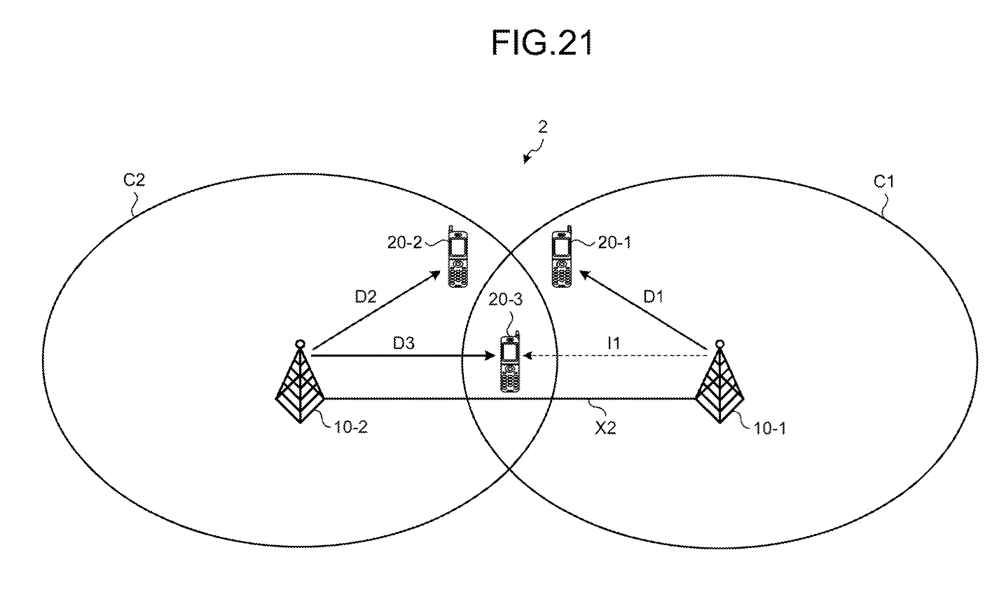

FIG. 21 is a diagram illustrating a communication system according to a third embodiment. In FIG. 21, this communication system 2 includes base stations 10-1 and 10-2, and user terminals 20-1 to 20-3. The base station 10-1 forms a cell C1 and the base station 10-2 forms a cell C2. The base station 10-1 and the base station 10-2 are adjacent to each other and the cell C1 and the cell C2 are adjacent to each other. The base station 10-1 and the base station 10-2 are connected to each other via an X2 interface. The user terminal 20-1 is located at a cell edge of the cell C1 and communicates with the base station 10-1. The user terminal 20-2 is located within the cell C2 and communicates with the base station 10-2. The user terminal 20-3 is located in an area in which the cell C1 and the cell C2 overlap each other and communicates with the base station 10-2. Thus, in FIG. 21, the base station 10-1 transmits data D1 to the user terminal 20-1 through cellular communication and the base station 10-2 transmits data D2 and data D3 to the user terminal 20-2 and the user terminal 20-3, respectively, through cellular communication.

In the following, the base station 10-1 and the base station 10-2, when one is not to be distinguished from the other, may be referred to generically as a “base station 10”.

Because the user terminal 20-1 is located at the cell edge of the cell C1, the transmission power for the data D1 transmitted from the base station 10-1 is high. In LTE, communication is performed using the same frequency in the cells that are adjacent to each other. As a result, the transmission of the data D1 undesirably increases interference I1 affecting the user terminal 20-3 that is communicating with the base station 10-2 that forms the cell C2 adjacent to the cell C1. An increase in the interference affecting the user terminal decreases system capacity. Thus, in the state illustrated in FIG. 21, the base station 10-1 monitors at all times the downlink transmission power to each individual user terminal 20 that communicates with the host base station, thereby determining whether any user terminal 20 to which the downlink transmission power is equal to or higher than a threshold TH2 exists. If no user terminal 20 to which the downlink transmission power is equal to or higher than the threshold TH2 exists, the communication system 2 continues to maintain the state illustrated in FIG. 21.

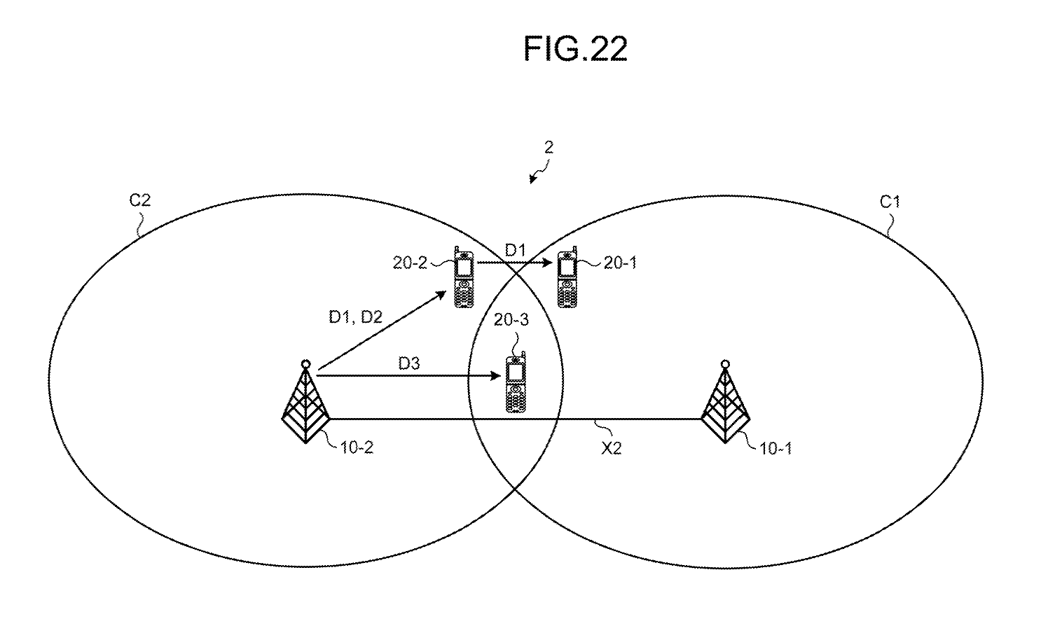

If a user terminal 20 to which the downlink transmission power is equal to or higher than the threshold TH2 exists, the base station 10-1 identifies the specific user terminal 20 to which the downlink transmission power is equal to or higher than the threshold TH2. Assume here that the downlink transmission power to the user terminal 20-1 (specifically, the downlink transmission power of the data D1) is equal to or higher than the threshold TH2. Specifically, assume that the interference I1 affecting the user terminal 20-3 by the transmission of the data D1 is equal to or greater than a threshold TH8. In this case, the communication system 2 shifts from the state illustrated in FIG. 21 to the state illustrated in FIG. 22. FIG. 22 is an example diagram illustrating the communication system according to the third embodiment. It is to be noted that the user terminal 20-2, because being located close to the user terminal 20-1, is capable of D2D communication with the user terminal 20-1. In addition, the user terminal 20-2, because being located within the cell C2 formed by the base station 10-2, is capable of cellular communication with the base station 10-2. Thus, in FIG. 22, a transmission originator of the data D1 addressed to the user terminal 20-1 is changed from the base station 10-1 to the base station 10-2 and the transmission destination of the data D1 from the base station 10-2 is set to the user terminal 20-2. This setting causes the data D1 addressed to the user terminal 20-1 to be transmitted to the user terminal 20-1 by way of the user terminal 20-2. Additionally, the change of the transmission originator of the data D1 from the base station 10-1 to the base station 10-2 results in the transmission of the data D1 from the base station 10-1 to the user terminal 20-1 to be cancelled. Thus, the shift of the communication system 2 from the state illustrated in FIG. 21 to the state illustrated in FIG. 22 eliminates the great interference IL affecting the user terminal 20-3, so that reduction in the system capacity can be prevented.

Configuration of Base Station

The base station in the third embodiment is configured in the same manner as the base station in the first embodiment (FIG. 4) and descriptions thereof will be omitted.

Configuration of User Terminal

The D2D terminal in the third embodiment is configured in the same manner as the D2D terminal in the first embodiment (FIG. 5) and descriptions thereof will be omitted.

Processing Sequence Performed by Communication System

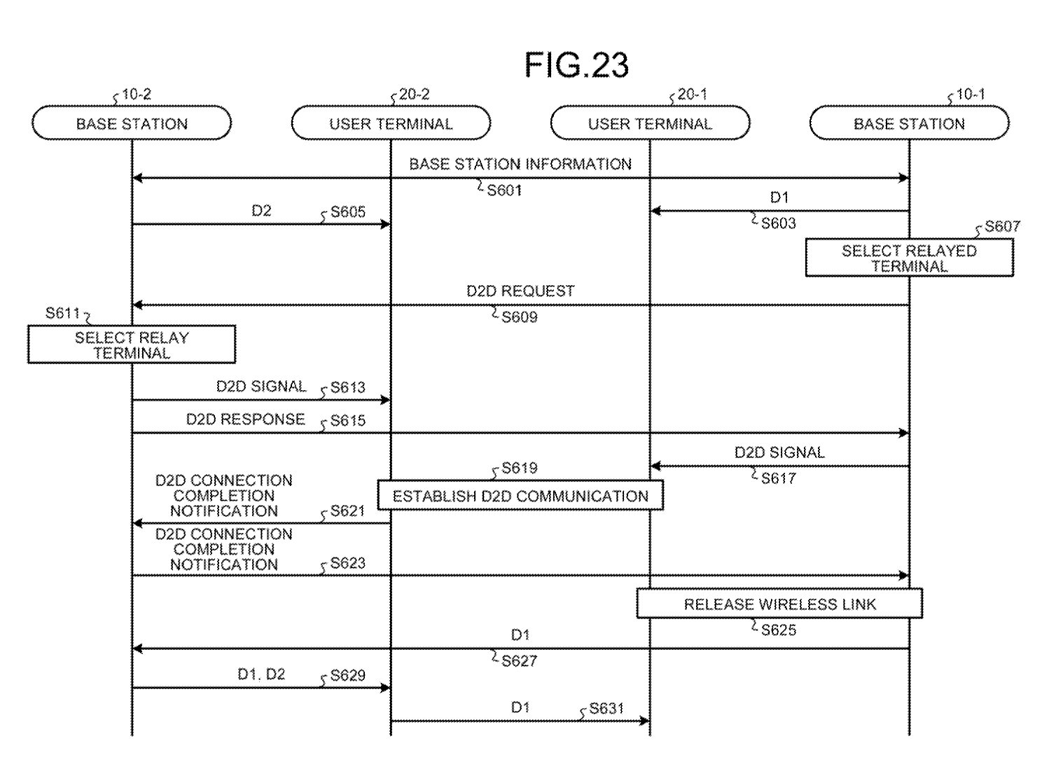

FIG. 23 is a diagram illustrating a processing sequence performed by the communication system according to the third embodiment.

In the communication system 2, a communication control unit 14 of the base station 10-1 and a communication control unit 14 of the base station 10-2 exchange base station information via the X2 interface (Step S601).

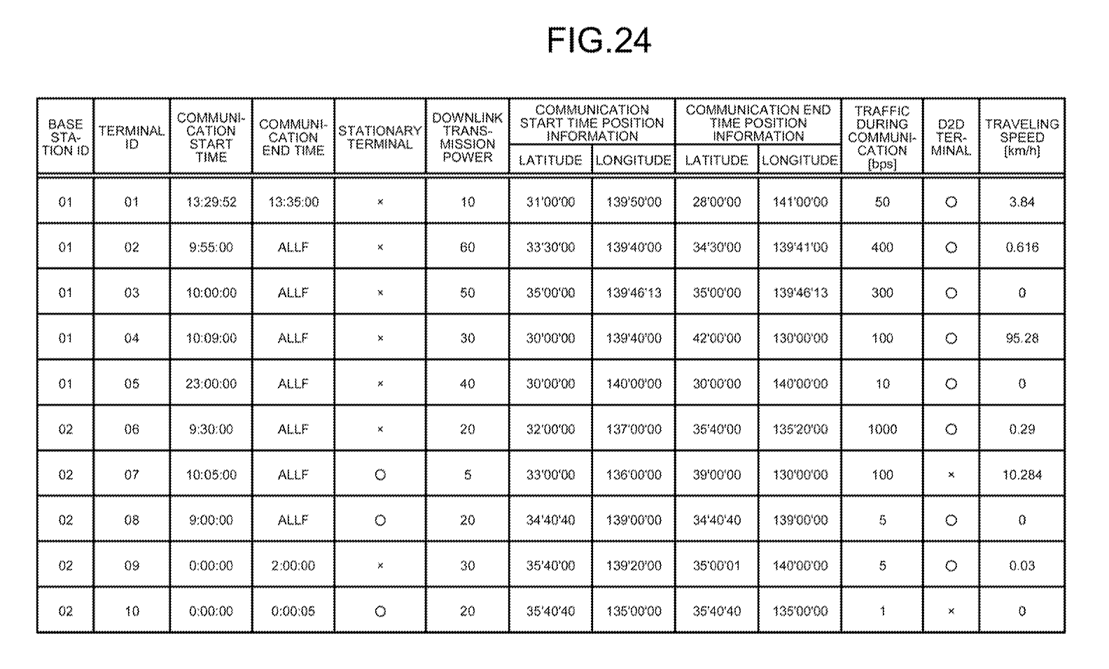

The exchange of the base station information is repeated at predetermined intervals. The base station information contains information on states of the user terminals 20 and 30 connected to the respective base stations 10. The base station information is either monitored by a monitoring unit 15 or stored in an information storage unit 16. For example, the base station information transmitted from the base station 10-1 identified by a base station ID of 01 includes information associated with the base station ID of 01 out of information of different items depicted in FIG. 24. In FIG. 24, the information associated with the base station ID of 01 includes information on the user terminals connected to the base station 10-1 (specifically, the user terminals identified by terminal IDs of 01 to 05). The base station information transmitted from the base station 10-2 identified by a base station ID of 02 includes information associated with the base station ID of 02 out of the information of different items depicted in FIG. 24. In FIG. 24, the information associated with the base station ID of 02 includes information on the user terminals connected to the base station 10-2 (specifically, the user terminals identified by terminal IDs of 06 to 10).

The communication control unit 14 of the base station 10-1 merges the base station information managed by the base station 10-1 (specifically, the information associated with the base station ID of 01) with the base station information received from the base station 10-2 (specifically, the information associated with the base station ID of 02) and stores the merged information in the information storage unit 16. Similarly, the communication control unit 14 of the base station 10-2 merges the base station information managed by the base station 10-2 (specifically, the information associated with the base station ID of 02) with the base station information received from the base station 10-1 (specifically, the information associated with the base station ID of 01) and stores the merged information in the information storage unit 16. The base station information is thus synchronized between the base station 10-1 and the base station 10-2 in the state as illustrated in FIG. 24.

At Step S603, the base station 10-1 transmits the data D1 to the user terminal 20-1.

At Step S605, the base station 10-2 transmits the data D2 to the user terminal 20-2.

At Step S607, the communication control unit 14 of the base station 10-1 selects a relayed terminal. The relayed terminal is selected in the same manner as in the first embodiment (FIG. 9), except that the base station 10-1 selects the relayed terminal from among the user terminals connected to the base station 10-1 (specifically, the user terminals identified by the terminal IDs of 01 to 05 in FIG. 24) defined as the candidates for the relayed terminal. A specific example of the process for selecting the relayed terminal will be described later. Assume here that the user terminal 20-1 is selected as the relayed terminal.

At Step S609, the communication control unit 14 of the base station 10-1 transmits a D2D request to the base station 10-2. The D2D request transmitted at Step 3609 includes the terminal ID of the relayed terminal selected at Step S607 and position information that indicates the current position of the relayed terminal (specifically, the terminal ID and the current position information of the user terminal 20-1). It is noted that, if the selection of the relayed terminal fails at Step S607, no D2D request is transmitted at Step S609 and the process returns to Step S601.

At Step S611, the communication control unit 14 of the base station 10-2 that has received the D2D request from the base station 10-1 selects a relay terminal. The relay terminal is selected in the same manner as in the first embodiment (FIG. 10), except that the base station 10-2 selects the relay terminal from among the user terminals connected to the base station 10-2 (specifically, the user terminals identified by the terminal IDs of 06 to 10 in FIG. 24) defined as the candidates for the relay terminal. A specific example of the process for selecting the relay terminal will be described later. Assume here that the user terminal 20-2 is selected as the relay terminal.

At Step S613, the communication control unit 14 of the base station 10-2 transmits a D2D signal to the user terminal 20-2. The D2D signal transmitted at Step S613 includes the terminal ID of the relayed terminal (specifically, the terminal ID of the user terminal 20-1). It is noted that, if the selection of the relay terminal fails at Step S611, no D2D signal is transmitted at Step S613 and the process returns to Step S601.

At Step S615, the communication control unit 14 of the base station 10-2 transmits, to the base station 10-1, a D2D response in response to the D2D request received at Step S609. The D2D response at Step S615 includes the terminal ID of the relay terminal (specifically, the terminal ID of the user terminal 20-2).

At Step S617, the communication control unit 14 of the base station 10-1 that has received the D2D response from the base station 10-2 transmits a D2D signal to the user terminal 20-1. The D2D signal at Step S617 includes the terminal ID of the relay terminal (specifically, the terminal ID of the user terminal 20-2).

At Step S619, the D2D communication is established between the user terminal 20-2 and the user terminal 20-1 using the terminal ID included in the D2D signal at Step 2613 and the terminal ID included in the D2D signal at Step S617. This establishment of D2D communication starts the D2D communication between the user terminal 20-2 as the relay terminal and the user terminal 20-1 as the relayed terminal.

At Step S621 following the establishment of the D2D communication, the user terminal 20-2 transmits, to the base station 10-2, a D2D connection completion notification that indicates that the D2D communication with the user terminal 20-1 has been established.

At Step S623, the base station 10-2 forwards the D2D connection completion notification received at Step S621 to the base station 10-1.

At Step S625, the communication control unit 14 of the base station 10-1 that has received the D2D connection completion notification from the base station 10-2 releases a wireless link between the base station 10-1 and the user terminal 20-1 as the relayed terminal.

At Step S627, the communication control unit 14 of the base station 10-1 transmits the data DL, not to the user terminal 20-1, but to the base station 10-2. The base station 10-2 receives the data D1 from the base station 10-1.

At Step S629, the communication control unit 14 of the base station 10-2 transmits the data 01 and the data D2 to the user terminal 20-2 as the relay terminal. The user terminal 20-2 receives the data D1 and the data D2.

At Step S631, a communication control unit 23 of the user terminal 20-2 relays to transmit, to the user terminal 20-1, the data D1 out of the data D1 and the data D2 received at Step S629.

Specific Example of Selection Processes

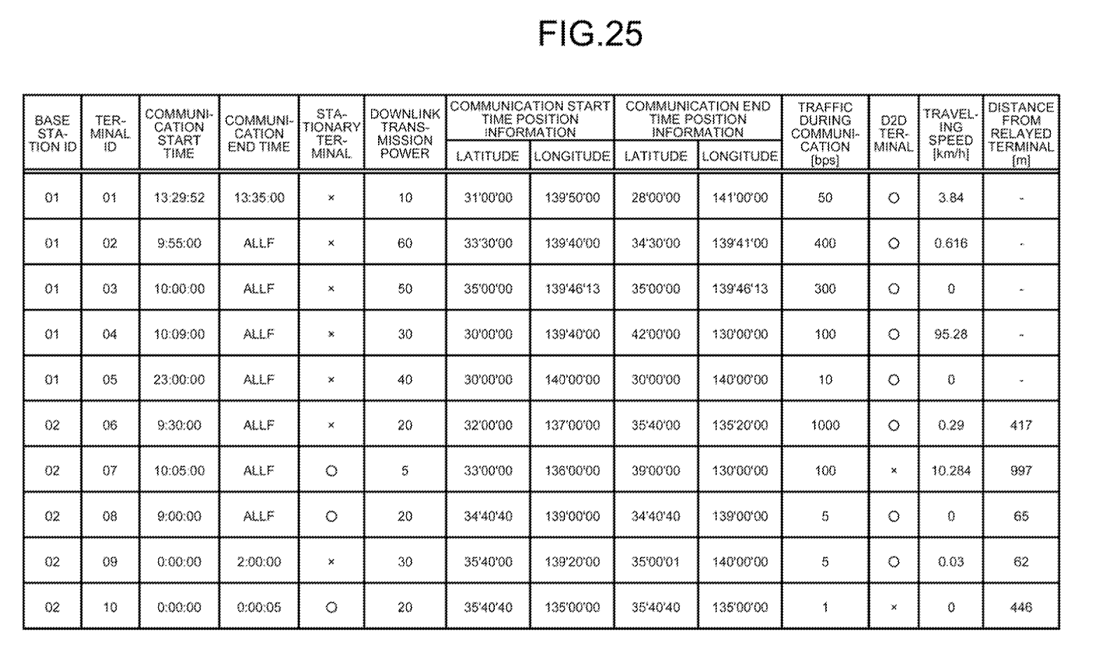

The following describes specific examples of the processes for selecting the relayed terminal and the relay terminal. FIGS. 24 and 25 are tables for illustrating specific examples of the selection processes according to the third embodiment. The information storage unit 16 of each of the base station 10-1 and the base station 10-2 stores the base station information that includes information on the different items depicted in FIG. 24 and that is updated from time to time as the base station information is exchanged at Step S601 (FIG. 23).

As illustrated in FIG. 24, the communication control unit 14 of the base station 10-1 has previously identified information on each of the items for each of the user terminals identified by the terminal IDs of 01 to 05 (specifically, the user terminals connected to the base station 10-1).

The communication control unit 14 of the base station 10-1, by following the flowchart illustrated in FIG. 9, selects a relayed terminal from among the user terminals identified by the terminal IDs of 01 to 05 defined as the candidates for the relayed terminal. Exemplarily, assume that the threshold TH2 is “25” and the threshold TH3 is “10 km/h” in FIG. 9.

Thus, in FIG. 24, out of the user terminals identified by the terminal IDs of 01 to 05, the user terminals that satisfy both of the conditions of Step S201 and Step S203 in FIG. 9 are the user terminals identified by the terminal IDs of 02 to 05.

The user terminals that satisfy the condition of Step S205 are the user terminals identified by the terminal IDs of 02, 03, and 05 out of the user terminals identified by the terminal IDs of 02 to 05.

The user terminals identified by the terminal IDs of 02, 03, and 05, each of which is a D2D terminal, satisfy the condition of Step S207.

The sorting performed at Step S209 yields a relayed terminal candidates list, and the relayed terminal candidates list at Step S211 looks like as illustrated in FIG. 12.

The communication control unit 14 of the base station 10-1 then selects, at Step S213, the user terminal identified by the terminal ID of 02 as the relayed terminal. The user terminal identified by the terminal ID of 02 selected as the relayed terminal is, for example, the user terminal 20-1 in FIGS. 21 and 22.

Meanwhile, as illustrated in FIG. 24, the communication control unit 14 of the base station 10-2 has previously identified information on each of the items for each of the user terminals identified by the terminal IDs of 06 to 10 (specifically, the user terminals connected to the base station 10-2).

The communication control unit 14 of the base station 10-2 thus selects a relay terminal in accordance with the flowchart illustrated in FIG. 10 from among the user terminals identified by the terminal IDs of 06 to 10 defined as the candidates for the relay terminal. Specifically, in the third embodiment, the repeating sequence of the loop 2 is performed for each of all user terminals connected to the base station 10-2. Exemplarily, assume that the threshold TH4 is “100 m”, the threshold TH5 is “10 bps”, the threshold TH6 is “3600 seconds”, and the threshold TH7 is “10 km/h” in FIG. 10. The current time (HH:MM:SS) is “2:45:00”.

At Step S301 illustrated in FIG. 10, the communication control unit 14 of the base station 10-2 calculates, for each of all user terminals identified by the terminal IDs of 06 to 10, the distance from the user terminal identified by the terminal ID of 02 (specifically, the relayed terminal). FIG. 25 depicts results of the calculations.

Thus, in FIG. 25, out of the user terminals identified by the terminal IDs of 06 to 10, the user terminals that satisfy both of the conditions of Step S301 and Step S303 are the user terminals identified by the terminal IDs of 08 and 09.

The user terminals identified by the terminal. IDs of 08 and 09 are each a D2D terminal and thus each satisfy the condition of Step S305.

The user terminal identified by the terminal ID of 08 is a stationary terminal (Yes at Step S307) and the user terminal identified by the terminal ID of 09 is a mobile terminal (No at Step S307).

Furthermore, the user terminal identified by the terminal ID of 09 satisfies both of the conditions of Step S309 and Step S311.

Thus, the performance of sorting at Step S313 yields a result that looks like as illustrated in FIG. 14.

Of the user terminals identified by the terminal IDs of 08 and 09, the user terminal identified by the terminal ID of 08 is a stationary terminal, so that the determination made at Step S315 is “Yes”. This causes the communication control unit 14 of the base station 10-2 to select, at Step S317, the user terminal identified by the terminal ID of 08 as the relay terminal. The user terminal identified by the terminal ID of 08 selected as the relay terminal is, for example, the user terminal 20-2 in FIGS. 21 and 22.

When the relay terminal is in the idle state, preferably the communication control unit 14 of the base station 10-2 starts cellular communication with the relay terminal as illustrated in FIG. 7 as in the first embodiment.

As described above, in the third embodiment, when the downlink transmission power from the base station 10-1 to the user terminal 20-1 is equal to or higher than the threshold TH2, the base station 10-2 transmits the data D1 addressed to the user terminal 20-1 to the user terminal 20-2. The user terminal 20-2 then relays to transmit the data D1 to the user terminal 20-1. At this time, the base station 10-1 cancels the transmission of the data D1 to the user terminal 20-1.

The foregoing arrangement eliminates great interference from the base station 10-1 affecting the user terminals 20 and 30 located in the cell C2 formed by the base station 10-2, so that reduction in the system capacity can be prevented.

### [d] Fourth Embodiment

In the third embodiment, the base station that selects the relayed terminal differs from the base station that selects the relay terminal. In contrast, a fourth embodiment relates to an arrangement in which a single base station selects both the relayed terminal and the relay terminal. The following describes only differences from the third embodiment.

Configuration of Communication System

The communication system in the fourth embodiment is configured in the same manner as the communication station in the third embodiment (FIGS. 21 and 22) and descriptions thereof will be omitted.

Configuration of Base Station

The base station in the fourth embodiment is configured in the same manner as the base station in the first embodiment (FIG. 4) and descriptions thereof will be omitted.

Configuration of User Terminal

The D2D terminal in the fourth embodiment is configured in the same manner as the D2D terminal in the first embodiment (FIG. 5) and descriptions thereof will be omitted.

Processing Sequence Performed by Communication System

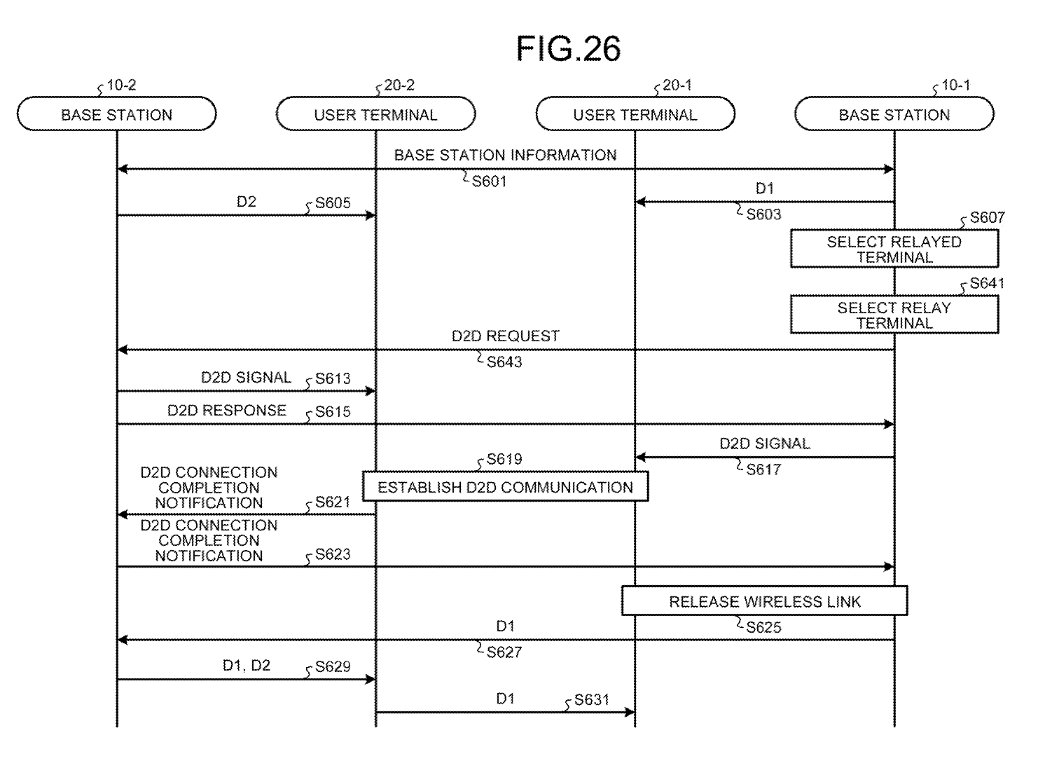

FIG. 26 is a diagram illustrating a processing sequence performed by the communication system according to the fourth embodiment. In FIG. 26, like reference numerals refer to corresponding steps described with reference to the third embodiment (FIG. 23) and descriptions thereof will be omitted. Specifically, the fourth embodiment differs from the third embodiment in that the base station 10-1 selects the relay terminal.

Specifically, at Step S641 illustrated in FIG. 26, the communication control unit 14 of the base station 10-1 that has selected the relayed terminal at Step S607 selects the relay terminal. The relay terminal is here selected, as in the third embodiment, from among the user terminals connected to the base station 10-2 (specifically, the user terminals identified by the terminal IDs of 06 to 10 in FIG. 24) defined as the candidates for the relay terminal. Assume that the user terminal 20-2 is selected as the relay terminal.

At Step S643, the communication control unit 14 of the base station 10-1 transmits a D2D request to the base station 10-2. The D2D request transmitted at Step S643 includes the terminal ID of the relayed terminal selected at Step S607 and position information that indicates the current position of the relayed terminal (specifically, the terminal ID and the current position information of the user terminal 20-1). The D2D request transmitted at Step S643 further includes the terminal ID of the relay terminal selected at Step S641 (specifically, the terminal ID of the user terminal 20-2). It is noted that, if the selection of the relayed terminal fails at Step S607 or if the selection of the relay terminal fails at Step S641, no D2D request is transmitted at Step S643 and the process returns to Step S601.

The subsequent steps are the same as those in the third embodiment.

As described above, in the fourth embodiment, the base station 10-1 selects both the relayed terminal and the relay terminal. This arrangement allows reduction in the system capacity to be prevented as in the third embodiment.

### [e] Fifth Embodiment

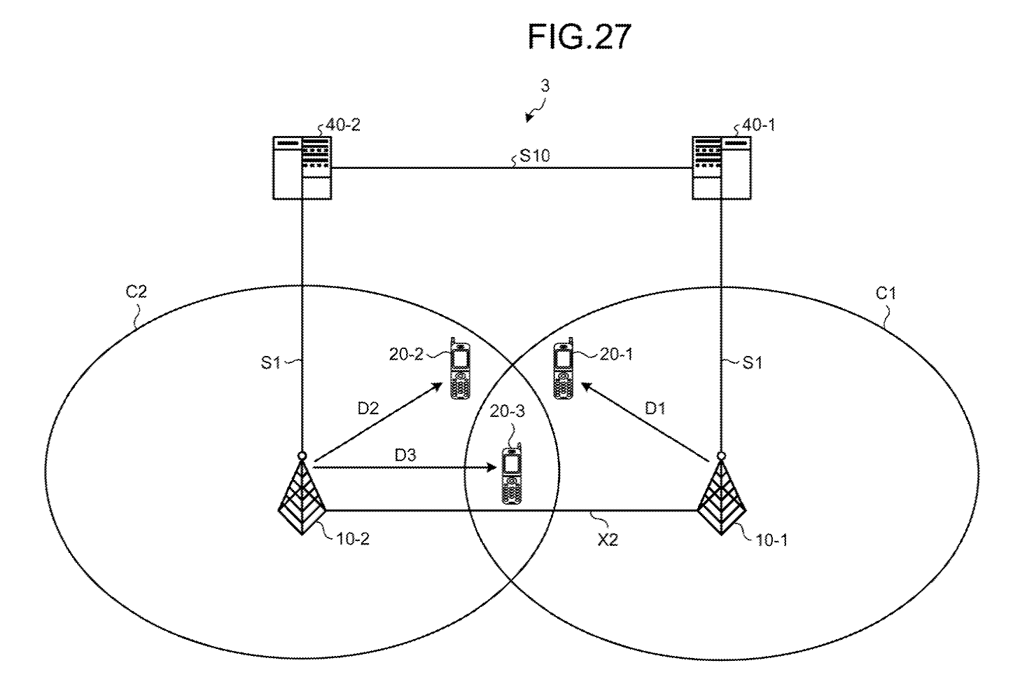

FIG. 27 is a diagram illustrating a communication system according to a fifth embodiment. In FIG. 27, this communication system 3 includes base stations 10-1 and 10-2, user terminals 20-1 to 20-3, and mobility management entities (MMEs) 40-1 and 40-2. In the following, the MME 40-1 and the MME 40-2, when one is not to be distinguished from the other, may be referred to generically as a “MME 40”. The MME 40 is an exemplary host controller of the base station 10.

As in the third embodiment, the base station 10-1 forms a cell C1 and the base station 10-2 forms a cell C2. The base station 10-1 and the base station 10-2 are adjacent to each other and the cell C1 and the cell C2 are adjacent to each other. The base station 10-1 and the base station 10-2 are connected to each other via an X2 interface. The user terminal 20-1 is located at a cell edge of the cell C1 and communicates with the base station 10-1. The user terminal 20-2 is located within the cell C2 and communicates with the base station 10-2. The user terminal 20-3 is located in an area in which the cell C1 and the cell C2 overlap each other and communicates with the base station 10-2. Thus, in FIG. 27, the base station 10-1 transmits data D1 to the user terminal 20-1 through cellular communication and the base station 10-2 transmits data D2 and data D3 to the user terminal 20-2 and the user terminal 20-3, respectively, through cellular communication.

Additionally, in FIG. 27, the base station 10 and the MME 40 are connected to each other via, for example, an S1 interface. The MME 40-1 and the MME 40-2 are connected to each other via, for example, an S10 interface. In FIG. 27, the MME 40-1 provides the base station 10-1 with the data D1 and the MME 40-2 provides the base station 10-2 with the data D2 and the data D3.

When congestion or failure occurs in a line (e.g., the S1 interface) between the base station 10 and the MME 40 and the communication between the base station 10 and the MME 40 is interrupted, data transmission from the MME 40 to the base station 10 becomes difficult, so that data transmission from the base station 10 to the user terminal 20 becomes difficult. For example, when congestion occurs in the line between the MME 40-1 and the base station 10-1 in FIG. 27, the communication between the MME 40-1 and the base station 10-1 is interrupted and, as a result, the transmission of the data D1 from the base station 10-1 to the user terminal 20-1 becomes difficult. Thus, the base station 10-1 constantly monitors occurrence of failure in the line between the host base station and the MME 40-1, thereby determining whether the occurrence of failure interrupts the communication between the host base station and the MME 40-1. If the communication between the base station 10-1 and the MME 40-1 is not interrupted, the communication system 3 maintains the state illustrated in FIG. 27.

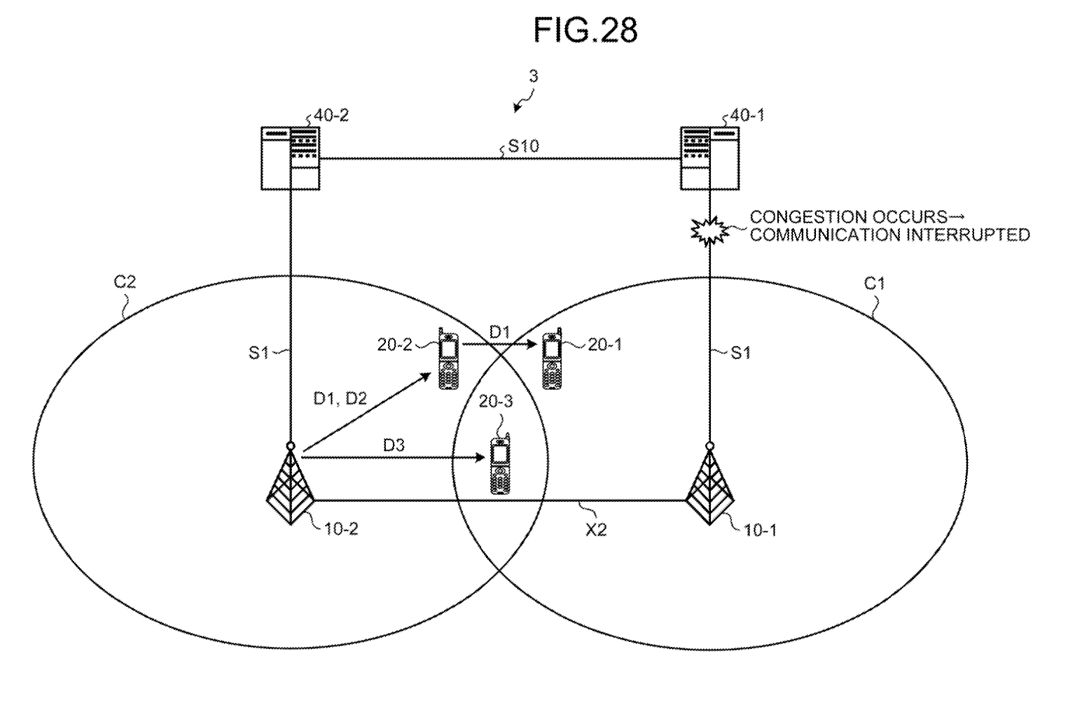

If the communication between the base station 10-1 and the MME 40-1 is interrupted, the communication system 3 shifts from the state illustrated in FIG. 27 to the state illustrated in FIG. 28. FIG. 28 is an example diagram illustrating the communication system according to the fifth embodiment. It is noted that the user terminal 20-2, because being located close to the user terminal 20-1, is capable of D2D communication with the user terminal 20-1. Additionally, the user terminal 20-2, because being located within the cell C2 formed by the base station 10-2, is capable of cellular communication with the base station 10-2. Thus, in FIG. 28, the transmission originator of the data D1 addressed to the user terminal 20-1 is changed from the MME 40-1 and the base station 10-1 to the MME 40-2 and the base station 10-2 and the transmission destination of the data D1 from the base station 10-2 is set to the user terminal 20-2. In addition, the MME 40-1 changes the transmission destination of the data D1 from the base station 10-1 to the MME 40-2. The foregoing setup causes the data D1 addressed to the user terminal 20-1 to be transmitted to the user terminal 20-1 by way of the user terminal 20-2. Thus, the shift of the communication system 3 from the state illustrated in FIG. 27 to the state illustrated in FIG. 28 enables the transmission of the data D1 to the user terminal 20-1 to be continued.

Configuration of Base Station

The base station in the fifth embodiment is configured in the same manner as the base station in the first embodiment (FIG. 4) and descriptions thereof will be omitted.

Configuration of User Terminal

The D2D terminal in the fifth embodiment is configured in the same manner as the D2D terminal in the first embodiment (FIG. 5) and descriptions thereof will be omitted.

Processing Sequence Performed by Communication System

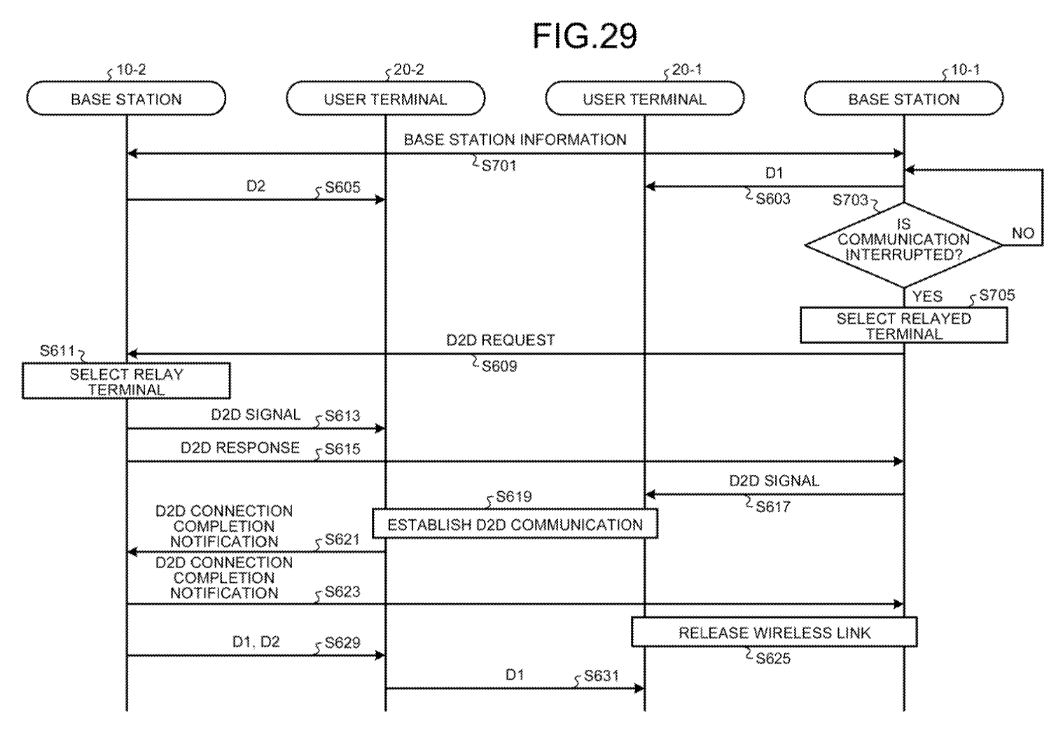

FIG. 29 is a diagram illustrating a processing sequence performed by the communication system according to the fifth embodiment.

In the communication system 3, a communication control unit 14 of the base station 10-1 and a communication control unit 14 of the base station 10-2 exchange the base station information via the X2 interface (Step S701).

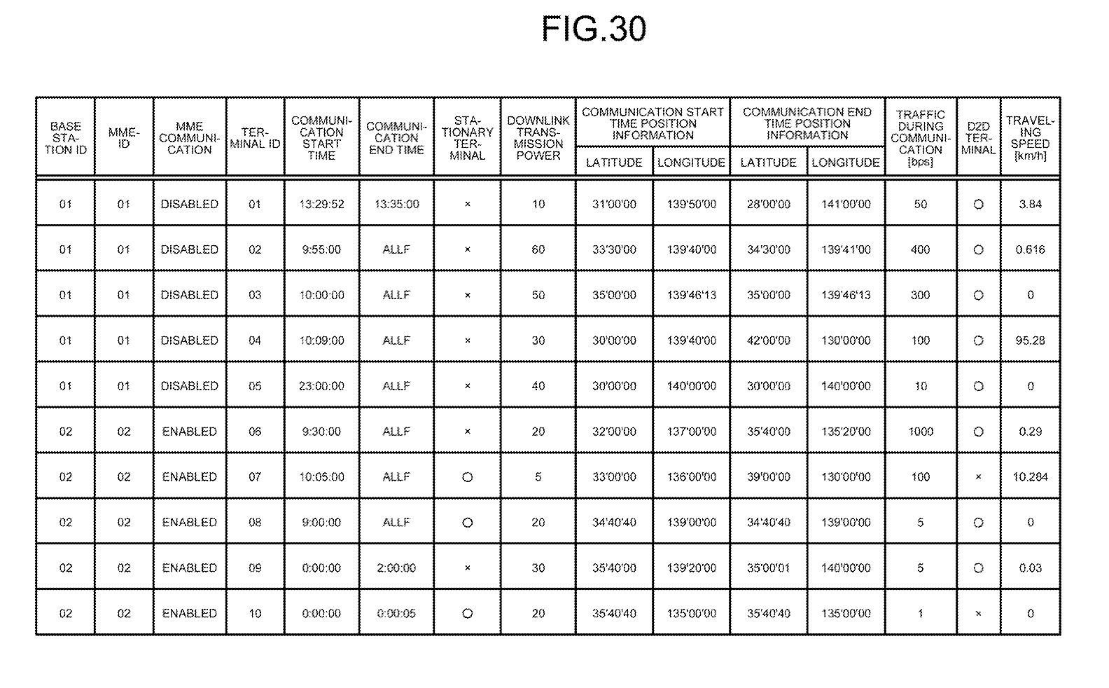

The exchange of the base station information is repeated at predetermined intervals. The base station information contains information on states of the user terminals 20 and 30 connected to the respective base stations 10. The base station information further includes information on whether the communication between each base station 10 and each MME 40 is enabled. “Enabled” communication between the base station 10 and the MME 40 indicates that the communication between the base station 10 and the MME 40 is not interrupted, while “disabled” communication between the base station 10 and the MME 40 indicates that the communication between the base station 10 and the MME 40 is interrupted. The base station information is either monitored by a monitoring unit 15 or stored in an information storage unit 16. For example, the base station information transmitted from the base station 10-1 identified by a base station ID of 01 includes information associated with the base station ID of 01 out of information of different items depicted in FIG. 30. In FIG. 30, the information associated with the base station ID of 01 includes information on whether the communication with the MME 40-1 (specifically, the MME identified by a MME-ID of 01) connected to the base station 10-1 is enabled and information on the user terminals connected to the base station 10-1 (specifically, the user terminals identified by terminal IDs of 01 to 05). The base station information transmitted from the base station 10-2 identified by a base station ID of 02 includes information associated with the base station ID of 02 out of the information of different items depicted in FIG. 30. In FIG. 30, the information associated with the base station ID of 02 includes information on whether the communication with the MME 40-2 (specifically, the MME identified by a MME-ID of 02) connected to the base station 10-2 is enabled, and information on the user terminals connected to the base station 10-2 (specifically, the user terminals identified by terminal IDs of 06 to 10).

The communication control unit 14 of the base station 10-1 merges the base station information managed by the base station 10-1 (specifically, the information associated with the base station ID of 01) with the base station information received from the base station 10-2 (specifically, the information associated with the base station ID of 02) and stores the merged information in the information storage unit 16. Similarly, the communication control unit 14 of the base station 10-2 merges the base station information managed by the base station 10-2 (specifically, the information associated with the base station ID of 02) with the base station information received from the base station 10-1 (specifically, the information associated with the base station ID of 01) and stores the merged information in the information storage unit 16. The base station information is thus synchronized between the base station 10-1 and the base station 10-2 in the state as illustrated in FIG. 30.

At Step S603, the base station 10-1 transmits the data D1 to the user terminal 20-1.

At Step S605, the base station 10-2 transmits the data D2 to the user terminal 20-2.

At Step S703, the communication control unit 14 of the base station 10-1 determines whether the communication between the base station 10-1 and the MME 40-1 is interrupted. If the communication between the base station 10-1 and the MME 40-1 is not interrupted (No at Step S703), the process returns to Step S603.

If the communication between the base station 10-1 and the MME 40-1 is interrupted (Yes at Step S703), the communication control unit 14 of the base station 10-1 selects a relayed terminal (Step S705). At Step S705, out of the user terminals 20 and 30 connected to the base station 10-1, all user terminals 20 are selected as the relayed terminals. The user terminal 20-1 is the only user terminal 20 connected to the base station 10-1.

The subsequent steps are the same as those in the third embodiment.

It is noted that, out of the data D1 and the data D2 transmitted from the base station 10-2 to the user terminal 20-2 at Step S629, the data D1 has been received by the base station 10-2 from the MME 40-1 via the MME 40-2.

Preferably, at the MME 40-1, too, it is determined whether the communication between the MME 40-1 and the base station 10-1 is interrupted and, if the communication between the MME 40-1 and the base station 10-1 is interrupted, the transmission destination of the data D1 is changed from the base station 10-1 to the MME 40-2.

If a plurality of user terminals 20 are connected to the base station 10-1, the steps from Step S705 onward are repeated for each of the user terminals 20.

Specific Example of Selection Processes

The following describes specific examples of the processes for selecting the relayed terminal and the relay terminal. FIG. 30 is a table for illustrating specific examples of the selection processes according to the fifth embodiment. The information storage unit 16 of each of the base station 10-1 and the base station 10-2 stores the base station information that includes information on the different items depicted in FIG. 30 and that is updated from time to time as the base station information is exchanged at Step S701 (FIG. 29).

As illustrated in FIG. 30, the communication control unit 14 of the base station 10-1 has previously identified the information on whether the communication with the MME identified by the MME-ID of 01 (specifically, the MIE 40-1 connected to the base station 10-1) is enabled. In addition, the communication control unit 14 of the base station 10-1 has previously identified information on each of the items for each of the user terminals identified by the terminal IDs of 01 to 05 (specifically, the user terminals connected to the base station 10-1).

If the communication with the MME identified by the MME-ID of 01 (specifically, the MME 40-1 connected to the base station 10-1) is determined to be interrupted, the communication control unit 14 of the base station 10-1 selects as a relayed terminal a D2D terminal from among the user terminals identified by the terminal IDs of 01 to 05. Because the user terminals identified by the terminal IDs of 01 to 05 are all D2D terminals as illustrated in FIG. 30, all of the user terminals identified by the terminal IDs of 01 to 05 are selected as the relayed terminals. Preferably, the relayed terminals are here selected in descending order of the downlink transmission power among the user terminals identified by the terminal IDs of 01 to 05. Thus, the communication control unit 14 of the base station 10-1 selects the user terminal identified by the terminal ID of 02 as the relayed terminal first. The user terminal identified by the terminal ID of 02 selected as the relayed terminal is the user terminal 20-1 in FIGS. 27 and 28.

Meanwhile, as illustrated in FIG. 30, the communication control unit 14 of the base station 10-2 has previously identified the information on whether the communication with the MME identified by the MME-ID of 02 (specifically, the MME 40-2 connected to the base station 10-2) is enabled. In addition, the communication control unit 14 of the base station 10-2 has previously identified information on each of the items for each of the user terminals identified by the terminal IDs of 06 to 10 (specifically, the user terminals connected to the base station 10-2).

The communication control unit 14 of the base station 10-2 then selects a relay terminal in accordance with the flowchart illustrated in FIG. 10 from among the user terminals identified by the terminal IDs of 06 to 10 defined as the candidates for the relay terminal. The subsequent steps are the same as those in the third embodiment, except that, in the fifth embodiment, the communication control unit 14 of the base station 10-2 selects the relay terminal when the communication with the MME identified by the MME-ID of 02 (specifically, the MME 40-2 connected to the base station 10-2) is not interrupted, but not when the communication with the MME identified by the MME-ID of 02 is interrupted.

As described above, in the fifth embodiment, when the communication between the base station 10-1 and the MME 40-1 is interrupted, the base station 10-2 receives the data D1 addressed to the user terminal 20-1 from the MME 40-2 and transmits the data D1 to the user terminal 20-2, and the user terminal 20-2 relays to transmit the data D1 to the user terminal 20-1.

The foregoing arrangement allows reception of the data D1 to be continued even when the communication between the base station 10-1 and the MME 40-1 is interrupted.

### [f] Sixth Embodiment

In the fifth embodiment, the base station selects the relay station. In contrast, in a sixth embodiment that will hereunder be described, the relayed terminal selects the relay terminal. The following describes differences from the fifth embodiment.

Configuration of Communication System

The communication system in the sixth embodiment is configured in the same manner as the communication station in the fifth embodiment (FIGS. 27 and 28) and descriptions thereof will be omitted.

Configuration of Base Station

The base station in the sixth embodiment is configured in the same manner as the base station in the first embodiment (FIG. 4) and descriptions thereof will be omitted.

Configuration of User Terminal

The D2D terminal in the sixth embodiment is configured in the same manner as the D2D terminal in the first embodiment (FIG. 5) and descriptions thereof will be omitted.

Processing Sequence Performed by Communication System

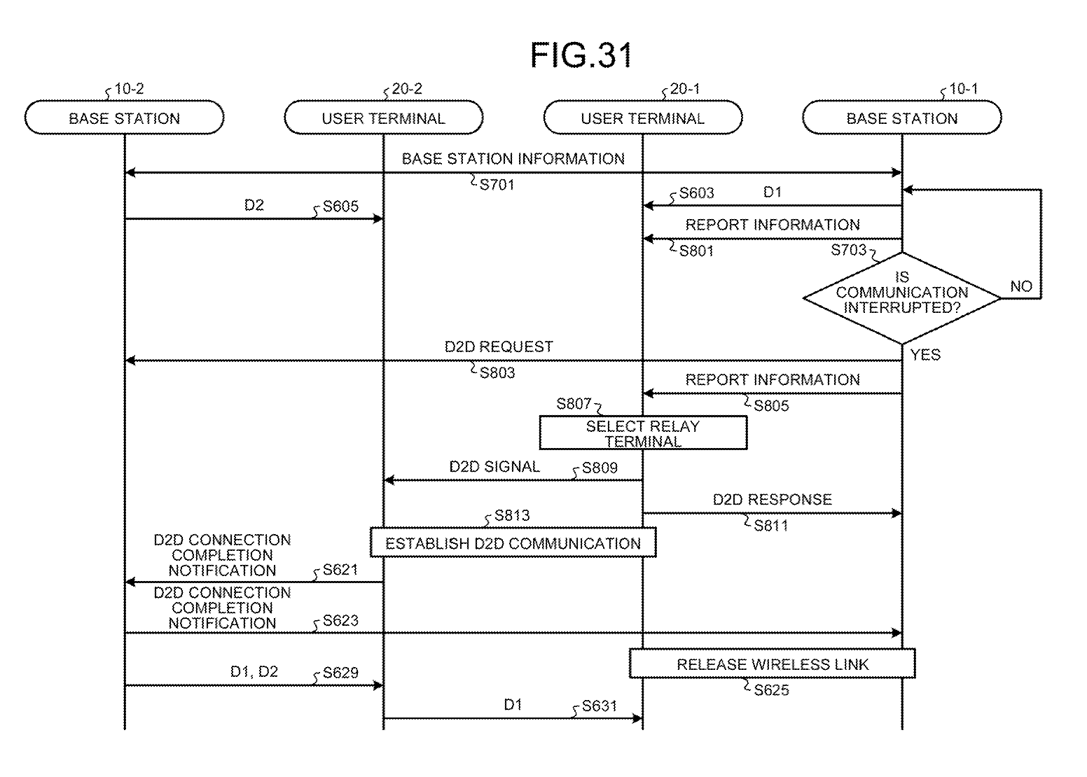

FIG. 31 is a diagram illustrating a processing sequence performed by the communication system according to the sixth embodiment. In FIG. 31, like reference numerals refer to corresponding steps described with reference to the fifth embodiment (FIG. 29) and descriptions thereof will be omitted.

At Step S801, a communication control unit 14 of a base station 10-1 transmits report information to a user terminal 20-1. The report information transmitted from the base station 10-1 to the user terminal 20-1 includes base station information that has been merged by the base station 10-1 (specifically, the information on all items depicted in FIG. 30). Assume, for example, that the report information at Step S801 includes “enabled” set for “MME communication” for both the MME-IDs of 01 and 02 in FIG. 30.

At Step S703, the communication control unit 14 of the base station 10-1 determines whether communication between the base station 10-1 and a MME 40-1 is interrupted. If the communication between the base station 10-1 and the MME 40-1 is not interrupted (No at Step S703), the process returns to Step S603.

If the communication between the base station 10-1 and the MME 40-1 is interrupted (Yes at Step S703), the communication control unit 14 of the base station 10-1 transmits a D2D request to the base station 10-2 (Step S803). The D2D request transmitted at Step S803 includes information that notifies that the communication between the base station 10-1 and the MME 40-1 is interrupted.

In addition, if the communication between the base station 10-1 and the MME 40-1 is interrupted (Yes at Step S703), the communication control unit 14 of the base station 10-1 updates base station information. Specifically, the communication control unit 14 changes the item of “MME communication” corresponding to the MME-ID of 01 out of the MME-IDs of 01 and 02 in FIG. 30 from “enabled” to “disabled”. The communication control unit 14 then transmits report information to the user terminal 20-1 (Step S805). The report information transmitted at Step S805 includes the updated base station information.

A communication control unit 23 of the user terminal 20-1 that has received the report information at Step S805 recognizes, using the base station information included in the report information, that the communication between the base station 10-1 that forms a cell C1 in which the user terminal 20-1 is located and the MME 40-1 is interrupted. The communication control unit 23 of the user terminal 20-1 then determines the host terminal to be the relayed terminal and selects a relay terminal that relays to transmit data D1 to the host terminal (Step S807). The relay terminal is selected, as in the fifth embodiment, in accordance with the flowchart illustrated in FIG. 10 from among the user terminals connected to the base station 10-2 (specifically, the base station identified by the base station ID of 02) (specifically, the user terminals identified by the terminal IDs of 06 to 10) defined as the candidates for the relay terminal. Assume here that the user terminal 20-2 is selected as the relay terminal.

At Step S809, the communication control unit 23 of the user terminal 20-1 transmits a D2D signal to the user terminal 20-2. The D2D signal transmitted at Step S809 includes the terminal ID of the relayed terminal (specifically, the terminal ID of the user terminal 20-1).

At Step S811, the communication control unit 23 of the user terminal 20-1 transmits a D2D response to the base station 10-1. The D2D response transmitted at Step S811 includes the terminal ID of the relay terminal (specifically, the terminal ID of the user terminal 20-2).

At Step S813, D2D communication is established between the user terminal 20-2 and the user terminal 20-1 on the basis of the terminal ID of the relay terminal selected at Step S807 and the terminal ID included in the D2D signal transmitted at Step S809 (specifically, the terminal ID of the relayed terminal). The establishment of D2D communication starts the D2D communication between the user terminal 20-2 as the relay terminal and the user terminal 20-1 as the relayed terminal.

As described above, in the sixth embodiment, the user terminal 20-1 as the relayed terminal selects the relay terminal. This arrangement also allows the user terminal 20-1 to continue receiving the data D1 even when the communication between the base station 10-1 and the MME 40-1 is interrupted, as in the fifth embodiment.

It is noted that, in the sixth embodiment, the report information transmitted from the base station 10-1 to the user terminal 20-1 includes the base station information as illustrated in FIG. 30. The base station information includes the position information of the relay terminal candidates. When the user terminal 20-1 as the relayed terminal is located such that D2D communication is difficult to establish with any of the relay terminal candidates, the user terminal 20-1 may guide the user of the user terminal 20-1 to a location where D2D communication with any of the relay terminal candidates can be performed.

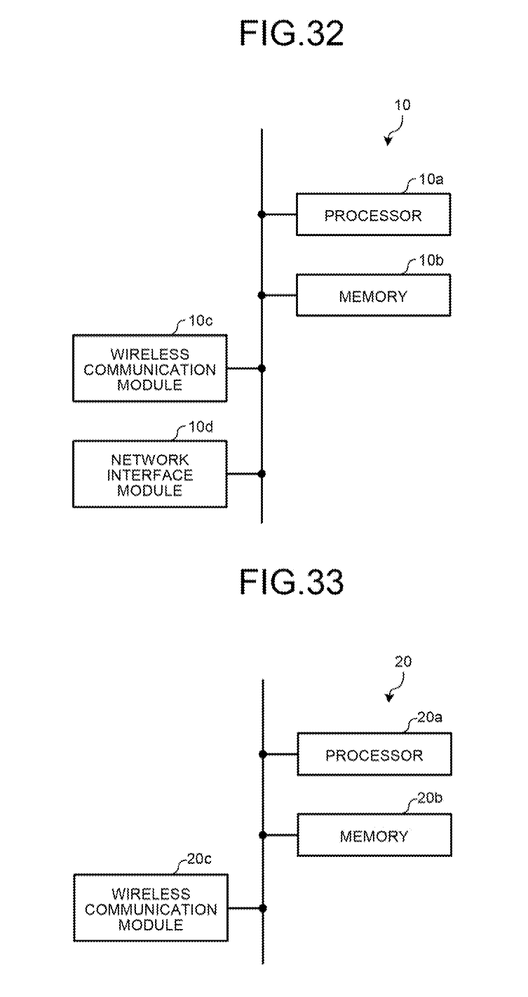

### [g] Other Embodiments

[1] The base station 10 can be achieved by the following hardware configuration. FIG. 32 is a diagram illustrating a hardware configuration of the base station. As illustrated in FIG. 32, the base station 10 includes, as hardware elements, a processor 10a, a memory 10b, a wireless communication module 10c, and a network interface module 10d. Nonlimiting examples of the processor 10a include, but are not limited to, a central processing unit (CPU), a digital signal processor (DSP), and a field programmable gate array (FPGA). Additionally, the base station 10 may include a large scale integrated circuit (LSI) that includes the processor 10a and a peripheral circuit. Nonlimiting examples of the memory 10b include, but are not limited to, a RAM such as a SDRAM, a ROM, and a flash memory.

The antenna 11 and the wireless communication unit 12 are achieved by the wireless communication module 10c. The BB processing unit 13, the communication control unit 14, and the monitoring unit 15 are achieved by the processor 10a. The information storage unit 16 is achieved by the memory 10b. The network interface unit 17 is achieved by the network interface module 10d.

[2] The user terminal 20 can be achieved by the following hardware configuration. FIG. 33 is an example diagram illustrating a hardware configuration of the user terminal. As illustrated in FIG. 33, the user terminal 20 includes, as hardware elements, a processor 20a, a memory 20b, and a wireless communication module 20c. Nonlimiting examples of the processor 20a include, but are not limited to, a CPU, a DSP, and a FPGA. Additionally, the user terminal 20 may include a LSI that includes the processor 20a and a peripheral circuit. Nonlimiting examples of the memory 20b include, but are not limited to, a RAM such as a SDRAM, a ROM, and a flash memory.

The antennas 211 and 221 and the wireless communication sections 212 and 222 are achieved by the wireless communication module 20c. The BB processing sections 213 and 223 and the communication control unit 23 are achieved by the processor 20a.

The disclosed embodiments can prevent reduction in system capacity.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station having an upper limit of total downlink transmission power, the base station comprising:
a monitoring unit that monitors the total downlink transmission power; and
a control unit that, when the total downlink transmission power is equal to or higher than a threshold, changes a transmission destination of data addressed to a first user terminal from the first user terminal to a second user terminal, the second user terminal being capable of direct communication with the first user terminal without requiring the base station between the second user terminal and the first user terminal, the second user terminal having, as downlink transmission power from the base station, second downlink transmission power lower than first downlink transmission power to the first user terminal.

2. The base station according to claim 1, wherein the control unit selects as the first user terminal a user terminal that has downlink transmission power from the base station equal to or higher than a threshold.

3. The base station according to claim 1, wherein the control unit selects as the first user terminal a user terminal that has a traveling speed lower than a threshold.

4. The base station according to claim 1, wherein the control unit selects as the second user terminal a user terminal that has traffic smaller than a threshold.

5. The base station according to claim 1, wherein the control unit selects as the second user terminal a user terminal that has an elapsed time since a communication end shorter than a threshold.

6. The base station according to claim 1, wherein the control unit selects as the second user terminal a user terminal that has a traveling speed lower than a threshold.

7. The base station according to claim 1, wherein the control unit selects a stationary terminal as the second user terminal.

8. The base station according to claim 1, wherein, when the second user terminal is in an idle state, the control unit transmits a paging signal to the second user terminal to start communication between the base station and the second user terminal.

9. The base station according to claim 1, wherein the control unit changes the transmission destination of data addressed to, in addition to the first user terminal, a third user terminal that is capable of communication with the second user terminal, from the third user terminal to the second user terminal.

10. A communication system comprising:
a base station that has an upper limit of total downlink transmission power;
a first user terminal; and
a second user terminal capable of direct communication with the first user terminal without requiring the base station between the second user terminal and the first user terminal, wherein
the base station monitors the total downlink transmission power, and
when the total downlink transmission power is equal to or higher than a threshold, the second user terminal that has, as downlink transmission power from the base station, second downlink transmission power lower than first downlink transmission power to the first user terminal relays to transmit, to the first user terminal, data addressed from the base station to the first user terminal.

11. A communication system comprising:
a first base station;
a second base station adjacent to the first base station;
a first user terminal located in a first cell formed by the first base station; and
a second user terminal that is located in a second cell formed by the second base station and that is capable of direct communication with the first user terminal without requiring the first base station between the second user terminal and the first user terminal, wherein
when downlink transmission power from the first base station to the first user terminal is equal to or higher than a threshold, the second base station transmits first data addressed to the first user terminal to the second user terminal, and
when the downlink transmission power from the first base station to the first user terminal is equal to or higher than the threshold, the second user terminal relays to transmit, to the first user terminal, the first data received from the second base station.

12. The communication system according to claim 11, wherein, when the downlink transmission power from the first base station to the first user terminal is equal to or higher than the threshold, the first base station cancels transmission of the first data to the first user terminal.

13. The communication system according to claim 11, wherein the first base station or the second base station selects as the second user terminal a user terminal that has traffic smaller than a threshold.

14. The communication system according to claim 11, wherein the first base station or the second base station selects as the second user terminal a user terminal that has an elapsed time since a communication end shorter than a threshold.

15. The communication system according to claim 11, wherein the first base station or the second base station selects as the second user terminal a user terminal that has a traveling speed lower than a threshold.

16. The communication system according to claim 11, wherein the first base station or the second base station selects a stationary terminal as the second user terminal.

17. The communication system according to claim 11, wherein, when the second user terminal is in an idle state, the second base station transmits a paging signal to the second user terminal to start communication between the second base station and the second user terminal.

18. A communication system comprising:
a first base station;
a second base station adjacent to the first base station;
a first user terminal located in a first cell formed by the first base station;
a second user terminal that is located in a second cell formed by the second base station and that is capable of direct communication with the first user terminal without requiring the first base station between the second user terminal and the first user terminal;
a first controller connected to the first base station; and
a second controller connected to the second base station, wherein
when communication between the first base station and the first controller is interrupted, the second base station receives, from the second controller, first data addressed to the first user terminal to transmit the first data to the second user terminal, and
when the communication between the first base station and the first controller is interrupted, the second user terminal relays to transmit, to the first user terminal, the first data received from the second base station.
